(19) United States
(12) Patent Application Publication
(10) Pub. No.: US 2023/0050219 A1
(43) Pub. Date: Feb. 16, 2023

(54) PHILANTHROPIC ACTION METHOD AND SYSTEM

(71) Applicant: Phaction, Inc., Severn, MD (US)

(72) Inventors: Brandon Wallerson, Severn, MD (US); Justin Ferguson, Silver Spring, MD (US)

(73) Assignee: Phaction, Inc., Severn, MD (US)

(21) Appl. No.: 17/388,700

(22) Filed: Jul. 29, 2021

(51) Int. Cl. G06Q 30/02; G06Q 50/00; H04L 29/08

(52) U.S. Cl. CPC G06Q 30/0279; G06Q 50/01; H04L 67/10

(57) ABSTRACT

A social media platform is provided. The social media platform, Phaction, implements digital activism, social action, societal understanding and social issue conversation. Powered by information and data from various sources, such as Clarintel, Inc., and user generated content and internal research approaches, Phaction provides the user with an environment built on cloud-based products that redefine social action. Phaction allows clients to access tools that enhance social action approaches both individually and in groups, to track, manage, and organize all social impact, capital, and philanthropic opportunities, and engage in social action, empathy building, and truth sharing, and keep up with the rising demand for social action involvement, societal understanding, and social justice advocacy. Clarintel offers analytical measures, resources, and research materials that allows stakeholders to enhance their social impact, deepen their social issue research approaches and understanding, and increase the personal and external value of nonprofit and philanthropic involvement.

### BACKGROUND

### 1. Field

The following description relates to a user controlled and managed social and philanthropic action method and social media crowdfunding and networking system.

### 2. Description of Related Art

Typically, in order to support a particular social cause, individuals may have to engage in a time consuming and tedious process to find a particular cause or social action, and donate to that particular cause or social issue. Additionally, it is difficult for individuals to create a social cause, or communicate with other individuals with similar concerns with regard to particular causes.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In a general aspect, a philanthropic method includes receiving data from a plurality of data sources at a first platform; transmitting the received data from the first platform to a second platform, and performing, by a user, one or more user-controlled philanthropic activities and social action operations at the second platform based on the received data.

The data may include philanthropic information and social information.

The second platform may be configured to provide education, social issues, and philanthropic resources.

The second platform may be configured to provide an account-based interface for a plurality of users to interact based on philanthropic interests and social interests. Other features and aspects will be apparent from the following detailed description, the drawings, and the claims.

### BRIEF DESCRIPTION OF DRAWINGS

FIG. 1 illustrates an example philanthropic system, in accordance with one or more embodiments.

FIG. 2 illustrates an example Accordion marketing model, in accordance with one or more embodiments.

FIG. 3 illustrates an example philanthropic campaign model, in accordance with one or more embodiments.

FIG. 4 illustrates an example Accordion advertising model in accordance with one or more embodiments.

FIG. 5 illustrates an example Advertising focused Accordion Ad structure, in accordance with one or more embodiments.

FIG. 6 illustrates an example Advertising focused Accordion Ad structure, in accordance with one or more embodiments.

FIG. 7 illustrates an example Advertising focused Accordion Ad structure, in accordance with one or more embodiments.

FIG. 8 illustrates an example Advertising focused Accordion Ad structure, in accordance with one or more embodiments.

FIG. 9 illustrates an example Advertising focused Accordion Ad structure, in accordance with one or more embodiments.

FIG. 10 illustrates an example Advertising focused Accordion Ad structure, in accordance with one or more embodiments.

FIG. 11 illustrates an example Advertising focused Accordion Ad structure, in accordance with one or more embodiments.

FIG. 12 illustrates an example Exploration network, in accordance with one or more embodiments.

FIG. 13 illustrates an example Enterprise network, in accordance with one or more embodiments.

FIG. 14 illustrates an example visionary and next generation network, in accordance with one or more embodiments.

FIG. 15 illustrates an example geo network, in accordance with one or more embodiments.

FIG. 16 illustrates an example network of network structure, in accordance with one or more embodiments.

FIG. 17 illustrates an example data sharing and messaging structure, in accordance with one or more embodiments.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that would be well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will fully convey the scope of the disclosure to one of ordinary skill in the art.

Herein, it is noted that use of the term “may” with respect to an example or embodiment, e.g., as to what an example or embodiment may include or implement, means that at least one example or embodiment exists in which such a feature is included or implemented while all examples and embodiments are not limited thereto.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

The features of the examples described herein may be combined in various ways as will be apparent after an understanding of the disclosure of this application. Further, although the examples described herein have a variety of configurations, other configurations are possible as will be apparent after an understanding of the disclosure of this application.

The drawings may not be to scale, and the relative size, proportions, and depiction of elements in the drawings may be exaggerated for clarity, illustration, and convenience.

Subsequently, examples are described in further detail with reference to the accompanying drawings.

The solution to the widespread lack of information regarding social action opportunities & social issues is separated into three branches:

### Phaction Application

A social media platform is provided. The social media platform, Phaction, implements free and open digital activism, social action, societal understanding and the social issue conversation. Powered by information and data from various sources, as well as user generated content and internal research approaches, Phaction provides the user with an environment built on a broad set of cloud-based products centered around revolutionizing and redefining social action. Phaction allows consumers, customers, and stakeholders to access the tools necessary for exponentially enhancing social action approaches both individually and in groups, for tracking, managing, and organizing all social impact, social capital, and philanthropic opportunities, for engaging in multiple forms of social action, empathy building, and truth sharing, and for keeping up with the rising demand for social action involvement, societal understanding, and social justice advocacy.

### Clarintel, Inc.

Clarintel, Inc. is a credible, analytical source of philanthropic and social information. In addition, Clarintel will offer a multitude of analytical measures, resources, and research material that provide the ability for stakeholders to enhance their social impact, deepen their social issue research approaches and understanding, and increase the personal and external value of nonprofit and philanthropic involvement. Initially, Claritnel, Inc. will be devoted to forming key partnerships within the social, private, and public sector, vetting and validating all philanthropic entities, including nonprofits, foundations, and individuals for Phaction, and aggregating social issue information and data. Clarintel, Inc. will be developed and scaled following the release of Phaction, Inc. At that time, all research approaches related to the patented social sector vetting will be transferred to Clarintel, Inc. and Phaction, Inc. will integrate with Clarintel, Inc. for the results of these approaches.

### The Sky

The Sky is a cloud computing database containing a cache of historical philanthropic and social issue related records including racial equity progression, ideological shifts, social impact and social capital measures, and philanthropic engagements and trends. The Sky allows the general public, enterprises, nonprofit organizations, small and medium sized businesses, and customers in the private and social sectors to access the keys needed to proactively, strategically, and quickly respond to social issues, to understand the impact of social action, and to revolutionize current research approaches. This database is used by both Phaction and Clarintel Inc. for data storage, retrieval, and publication. This database will initially be privy to only Clarintel Inc. and Phaction partners and scale with each respective entity before becoming publicly accessible.

Phaction redefines philanthropy as “acts of care towards another human being.” By redefining philanthropy and providing tools, resources and data that clarifies social issues, philanthropic endeavours, and nonprofit organizations, individuals are no longer limited in their philanthropic involvement to the current typicality of donations. Through Clarintel and Phaction, individuals can expand their philanthropic reach and engage in knowledgeable digital protests within the environment built by digital activists, for digital activists.

Phaction centralizes a variety of digital acts of care and provides the ability for nonprofits to create, manage, and track their own digital acts of care, and for users to engage in any digital act of care offered by credible nonprofits. Thus, individuals, businesses, and nonprofits can control, enhance, manage, and organize their own forms of digital activism, engage in knowledgeable and strategic social action, and comfortably express their support, empathy and truth in the environment built on care. Digital acts of care may be any action of goodwill taken via the Internet by an individual, group, or entity, to provision what is necessary for another individual, group or entity. This means anything done on Phaction, from reacting or liking a post to signing a petition to sharing a volunteer event and even charitable giving, may all be considered as digital acts of care.

### Phaction

Phaction Inc. (“Phaction”) is the first philanthropic network built to revolutionize social action. Before uniting the world, Phaction first builds a foundation based on clarity, intelligence, empathy, and connection, encompassed by an unwavering intention to positively change the world. Through a series of interactive stages called growth points, Phaction continuously revolutionizes, enhances, amplifies, and redefines community connections, social sector operations, collaborations, societal impact, and data innovations. Outlined below is Phaction's manifestation of a world built on truth, empathy, care, unity and universal human equity. Phaction's vision is to empower the entire social sector. The solution is created in a manner that scales to become the center of philanthropy and social action by meeting social sector needs. Given today's social climate and the nature of recent current events, Phaction partners with racial equity-based organizations, research centers, celebrities, influencers, and media sources directly or indirectly focused on African Americans, and scales and innovates its solution by iteratively invoking numerous growth hacking strategies focused on building brand value, proactively adapting to social sector and community needs, strategically responding to social issue occurrences, continuously innovating philanthropy through data and technology, and by collecting and analyzing community and social trends regarding social impact, social issues, social sector strategies, and philanthropic solutions.

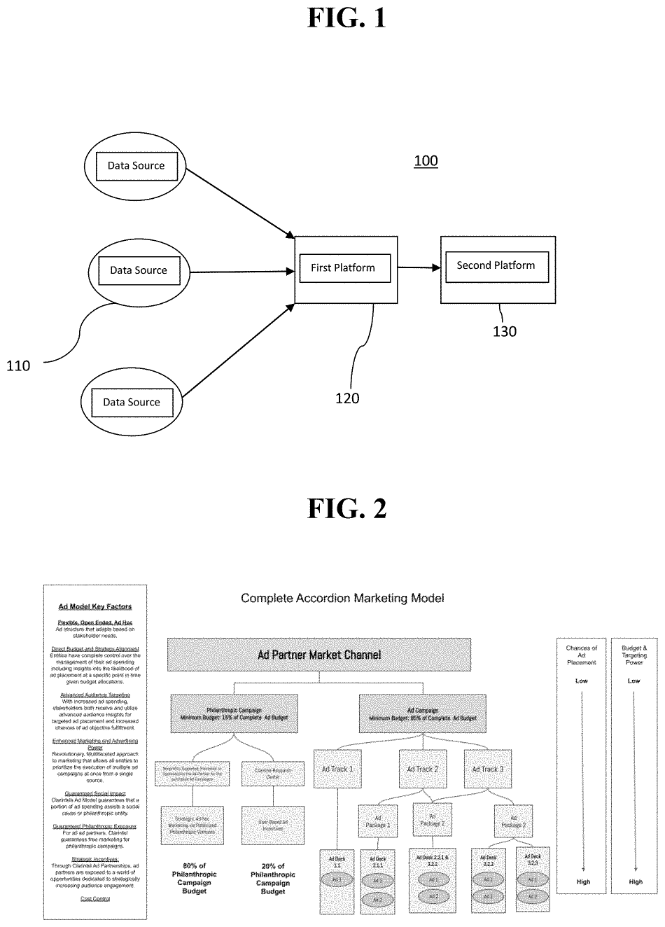

Referring to FIG. 1, a first platform 120, for example, a platform associated with Clarintel Inc., may collect or receive philanthropic and social information from entities 110 and sources including, but not limited to news and social media, researchers, industry professionals, reporters, journalists, bloggers, and freelance reporters and journalists. Upon collecting the information, Clarintel, Inc. may validate, and organize social sector, philanthropic, and social issue information among the collected information. This collected information may then be transmitted to a second platform, 130, for example, Phaction, Inc., which provides cloud-based tools for understanding, managing, and distributing actionable, educational, and social issue and philanthropic resources. Through an application such as the Phaction App, Phaction creates the space for all individuals to connect based on their philanthropic and social issue interests and the environment for social issue conversations, empathy building, and truth sharing.

### Phaction Service Models

Phaction offers a variety of services for the public, private, and social sectors to advance and enhance their philanthropic and social issues strategies and initiatives. By combining the below services, Phaction provides the world with a revolutionary way to engage in philanthropy within the environment built for social action. Each service model discussed below will be expanded and enhanced upon further development, research, and partnership.

### Software as a Service

1) The Philanthropic Network:

Powered by legitimate, credible social sector information from Clarintel and internal research and data collection endeavors, Phaction offers a social media platform consisting of a variety of free, cloud-based products dedicated to redefining and mastering individual social action and philanthropy. Following a multi-level account verification screening process, all individuals have access to the tools necessary for creating, engaging, promoting, and streamlining all digital acts of care including capabilities for building networks based on empathy, truth, and support for others fighting social issues across the nation.

2) Instant Action Collection & Multifaceted Philanthropy:

All philanthropic offerings collected and hosted on Phaction pheeds (philanthropic feeds) and pages by philanthropic entities may also be visible via the Instant Action Collection & Pheed. All Phaction members have access to the Instant Action Collection & Pheed and can engage in Multifaceted Philanthropy. Multifaceted Philanthropy provides Phaction members with the ability to donate to, or engage with, multiple philanthropic entities and their respective offerings at once. From the instant action collection, members can filter nonprofit organizations and their respective offerings by predetermined preferences and interests. Once filtering and selecting nonprofit entities and philanthropic offerings to donate to, Phaction members can control the amount donated to each entity and respective offering. Phaction ensures that the amount specified by users accurately reflects the amount donated to the entity or offering. All donations on Phaction can occur via the Phaction members' bank account, any form of cryptocurrency, apple pay, venmo, cash-app, credit & debit cards, as non-limited examples.

3) Social Sector Crowdsourcing:

Through the Phaction Application, individuals, organizations, and entities with high philanthropic standing can access, create, store, and execute a variety of innovative tools that enhance and strengthen all social sector crowdsourcing strategies. Crowdsourcing is the “practice of obtaining information or input into a task or project by enlisting the services of a large number of people, either paid or unpaid”. All accounts verified through Phaction are provisioned crowdsourcing tools for the tracking, management, organization, streamlining, and completion of various forms of charitable giving, petition, pledge, and sign-up opportunities. This also includes Phaction's solution to automate pledge, petition, and nonlegal document signing called One-Tap Signatures. One-Tap Signatures provide Phaction members with the ability to easily sign pledges and petitions with the tap of a finger. Although all crowdsourcing tools and opportunities are initially free, Phaction will charge social sector entities for additional promotion and marketing opportunities offered through the App.

4) Public Database of Verified Nonprofits, Foundations, and DACs:

Phaction provides free, open access to a centralized repository of nonprofits, foundations, and digital acts of care. All organizations, entities, and digital acts of care available to users are verified and trusted by Clarintel and Phaction.

5) Philanthropic Planning, Monitoring, and Management:

Whether creating, engaging, hosting, or executing social action and DAC strategies on Phaction, all members have the ability to track their philanthropic and social issue engagement in real time. Phaction provides each partner with the control over scheduling philanthropic ventures.

6) Engagement and Event Driven Feedback Loops:

In Psychology, a feedback loop is a system where outputs are fed back into the system as inputs, increasing or decreasing effects. Phaction offers engagement and event driven feedback loops in the form of replies, comments, mentions, surveys, polls, and gestures. Each medium provides Phaction Members with the ability to enhance their philanthropic presence and adapt social strategies based on the thoughts, feelings, and emotions concerning philanthropic endeavours, nonprofits, and social action.

### Infrastructure as a Service

1) Social Sector Data Organization and Storage:

As Phaction continues to scale, cloud services are expanded to include the provisioning of secure cloud space for all needs of the social sector including, but not limited to, data and application storage, management, and hosting. This service will be priced based on usage and restricted to entities verified by Clarintel and Phaction. Once established, verification will be performed solely by Clarintel, Inc.

2) The Secure Philanthropic Ecosystems:

Once platform stability has been established, Phaction will develop and provision secure copies of Phaction built to sustain employees within the public and private sectors. The Phaction copies, or ecosystems, will only be accessible to individuals from each respective organization and will contain philanthropic opportunities and entities chosen by executive leadership. Each ecosystem will be designed by each respective entity and act as an internal social media platform containing both actionable philanthropic resources and conversational capabilities to foster and grow internal company culture.

### Data as a Service

1) Insights:

Phaction offers a variety of free and commercial insights for members to understand and maximize their influence, philanthropic presence, and social impact. Insights will differ for members depending on account verification status and app capabilities. Insights are discussed below within the Insights and Analytics section.

2) Advertisements:

For advertisement partners, additional insights will be provided for promotional content.

3) Prediction as a Service:

Upon developing a deep understanding of the clients including expected behaviors and patterns, Phaction will expand its insights' approach to include prediction-based strategies. Predictive analysis will be used to determine future outcomes regarding social issues and philanthropic endeavours, audience behaviors including donors, volunteers, signees, participants, and general supporters, nonprofit and corporate philanthropic behaviors and reactions to social issues, and responses to social issues including philanthropic ventures, response strategies, and emotions.

### Consulting as a Service

Phaction offers consulting services independently and through partnerships with third party entities. Third party entities are able to purchase Phaction Data at a discounted price for the amplification and enhancement of any and all strategies indirectly or directly related to social issues, philanthropy, or any other area of interest as decided by the Phaction Board of Directors. Consulting strategies include, and are not limited to:

1) Marketing & Advertising Agency Services:

These services will focus on enhancing and assisting marketing strategies using social issue, thought, and emotion-based data. This includes assistance with marketing efforts and strategies occurring immediately after events related to, associated with, or reflecting social issues. Marketing and advertising agencies include, but are not limited to any and all entities working with or assisting nonprofit and for-profit entities with social issue or philanthropic related approaches.

2) Social Issue Solution, Response and Aid Services:

Phaction assists social sector and public sector organizations with creating proactive responses to social issues using data driven and predictive approaches. These entities include, but are not limited to legal and government agencies, nonprofit organizations, hospitals, community led organizations, and other first response and consulting entities.

3) Business Philanthropy, Corporate Strategies, and Executive Coaching Services:

Phaction partners with businesses, corporations, executive coaches and strategists, and business consultants to create and execute innovative philanthropic and diversity, equity, and inclusion strategies. Additionally, Phaction provides data to the aforementioned entities for the enhancement of emotional, social issue, marketing, branding, and philanthropic based approaches taken within or outside of Phaction Inc.

4) Content Creation and Branding Services:

Phaction offers content creation and branding services independently and through partnerships with third party entities. Third party entities include, but are not limited to individuals, consulting and public relations firms, branding services, and other independent individuals and entities operating on the behalf of another individual or entity.

5) Mental Health Services:

Phaction partners with third party organizations dedicated to improving mental health and emotional understanding. This includes entities dedicated to education, training, psychoanalytical approaches, and emotional based support measures taken for the betterment of society.

### 1) Account Creation

Phaction's experience begins with creating an account. Phaction offers, as an example, three types of accounts based on a verification process. A user on Phaction may either have an unverified account, a verified account representing public standing, or a philanthropically recognized account demonstrating philanthropic presence and activity. Each account is given different permissions and accesses to the Phaction App based on their Phaction Insignia. Below are the different types of Phaction accounts, the account sign-up and Phaction Insignia Process, and account capabilities and differences. All accounts have the option to be public or private.

### Account Sign Up Process:

The account sign-up process may be separated into five segments discussed below. The account sign-up process may be simplified through third party entities. Phaction utilizes open source tools such as, but not limited to, ID.me for identity and document proofing, authentication, and group affiliation verification for government and business entities across sectors. By incorporating the above tools, Phaction will substantially reduce the amount of time spent on the account creation process and dramatically enhance our security and fraud detection measures.

Public Account Information:

In the account sign-up process, general user information including the account creator's First Name, Last Name, Phone Number, Email Address, Birthday, Personality Type, Nouns & Pronouns, and Username is collected. This information will be used and displayed in the user profile. Phaction may connect all accounts to a driver's license and use software such as ID.me to scan driver's license information for increased security and reduced sign up time.

Confidential Account Information.

After collecting public account information, Phaction may collect information specific to DAC engagement. This includes collecting account financial information for donations, signature enablement for petitions and pledges, and information related to volunteer and participation sign up forms. All accounts are given the option to bypass this step for later completion.

User Interests

The information collected in this section will be used to determine user interests. Possible options for user interests may be presented to the user in the form of phillopics. The types of phillopics shown to users may be based on location (zip code, radius, state, city, county, region etc.), current and historical social issues, categories representing philanthropic opportunities, role models and important social sector leaders, and nonprofit entities featured on Phaction.

Philanthropic Role

Philanthropic roles dictate the responsibility or presence that an individual wants to publicly promote at any given time. This can be seen in the user profile and changed in the philanthropic organizer by the user. Philanthropic Roles influence the types of opportunities presented to the user.

Zodiac Signs

Accounts may also choose to publicly display their zodiac signs. Accounts that elect to publicly share this information may be asked for their time of birth and birth location. Once provided this information, Phaction produces the accounts zodiac birth chart. The account can choose the specific items to publicize from their zodiac birth chart. Given the individual's zodiac birth chart, Phaction will further enhance the accounts experience.

Questions for Additional Experience Framing

After creating an account, Phaction will provide users with the additional option to complete a questionnaire for building their philanthropic experience. Example questions are listed below and will be expanded upon further research and development.

TABLE 1

| | |
|---|---|
| Question | Ranking From 1-10 |

Social Awareness & Consciousness
Near-Sighted vs Far-sighted
Politically involved
Task-Oriented vs Relationship-Oriented
Problem-Oriented vs Solution-Oriented
Self-Oriented vs People-Oriented
What characteristics below best describe your
feelings towards philanthropy (Business-
minded, Passionate, Committed, Generous,
Optimistic, Trustworthy, Humble, High energy,
Low energy, Enthusiastic, Grateful, Altruistic,
Empathetic, Anxious, Emotionally fueled).
What characteristics below best describe your
feelings towards racial equity related social
issues? (Business-minded, Passionate,
Committed, Generous, Optimistic,
Trustworthy, Humble, High energy, Low
energy, Enthusiastic, Grateful, Altruistic,
Empathetic, Anxious, Emotionally fueled).

### Unverified Account

A Phaction account may be owned or controlled by a single user. This account is the first account created by all individuals, organizations, nonprofits, and entities. If any of the below accounts violate Phaction Terms and Agreements and their insignia is revoked, they will default to this type of account. The unverified account has basic permissions including but not limited to post and DAC interactions. These accounts do not have a Phaction Insignia.

### Verified Accounts Overview

Phaction examines multiple factors to determine if user, nonprofit, and business accounts are in the public sphere. A verified account is represented with a Phaction Insignia to inform individuals that Phaction has confirmed that the account in question is the legitimate presence of the person, entity, or brand of interest. Verified accounts are public by default and clearly represented with an insignia. There are two types of verifications: Public Standing and Philanthropic Prestige.

### Public Standing Verified Account

To be verified for a public standing means that Phaction has confirmed that the account representing a public figure is authentic and managed by the real person or entity. To be considered for a Public Standing Phaction Insignia, an account must be publicly notable, legit, distinct, and active as detailed below. This account is public by default and the verification status is represented with a blue insignia.

1.1 Public Standing Verification Criteria

If an account wants to be verified for its public status, the account holder can initiate the public standing verification process after completing the unverified account set up by selecting the public standing verification option. This option is also available under the account settings component of the account profile. Upon initiating this process, their account will be submitted to a verification process conducted by Phaction Account Verification Team. The criteria for Public Standing Verification are below:

1.1.1 Public Notability

The Client account represents a well-known, prominent, recognizable, frequently searched person, business, nonprofit, brand, organization, or entity. Multiple public news, blogs, and social media sources are recognized as sources for review. In addition, sources such as Wikipedia articles that meet the notability standards for people and notability standards for organizations and companies may be utilized. In addition to confirming the identity of the account and account admin, Phaction will verify the following types of accounts based on the below criteria. Within the below criteria, Phaction may confirm qualifying accounts through partnerships or direct outreach.

1.2 Government

These are accounts represented, controlled, or managed by government officials and entities including, but not limited to: public utilities and structural institutions, all elected, appointed, and designated officials, diplomats, governors, representatives, spokespersons, officers, heads of state, leaders, and official candidates for state or national level public offices. Qualifying government personnel will be selected based on community involvement, historical association and involvement with specific social issues, and other factors completely independent of politics and political affiliations.

For qualification, the account or account administrator must be publicly referenced on an official government website, identifiable within a credible publication, or be referenced multiple times in official news media.

1.3 Nonprofit, Foundations, Businesses, Brands, and Organizations

These are accounts that represent prominent, recognizable nonprofits, businesses, brands, foundations, and organizations including affiliated accounts. These include: the entity as a whole, executive and leadership teams, and other prominent executives, directors, company spokespersons, and vice presidents. To qualify accounts must meet 2 of the following requirements:

A. Existence in any credible, public index including but not limited to Google Trends, stock exchanges, Wikipedia articles that meet their notability standards, and databases such as Candid and Global Giving.

B. Within the last six months, the account must be referenced or mentioned by at least three major, notable public sources not limited to official, reputable news entities, reporters, researchers, and journalists including freelancers.

C. The account champions are in the top 1% of active accounts sharing similar interests or located in the same geographic area.

1.4 News Entities, Reporters and Journalists

These accounts represent all credible, qualifying news and information sources. In addition to meeting the criteria of this policy, the accounts are public and directly reflect the entities official DBA name. In addition, all information shown via Phaction must coincide with the qualifying entities URL.

Qualifying entities and organizations include broadcast, cable, digital, satellite, and streaming television and radio news programs, stations, channels, and networks; newspapers, magazines, digital and analog news publishers, journalists; and related sources. In addition, all qualifying entities must display a history of adherence to the official standards for journalism detailed by the Society of Professional Journalists, Independent Press Standards Organization, and International Federation of Journalists or have committed to the International Fact-Checking Network's code of principles prior to applying for verification. New or experienced independent and freelance reporters and journalists can achieve verification by providing 3 bylines or credits from qualifying publications or sources published within six months prior to applying.

1.5 Entertainment & Media

These accounts represent major entertainment and media companies outside of news entities and include film studios, production companies, TV networks, streaming and music services, and other music entities and media providers. Official accounts of productions associated with these entities, such as films, events/festivals, or TV shows, may be verified if the connection to the verified account is clear on the accounts profile, and there is an official URL associated with the production.

Individual accounts artists, actors, directors, and similar public facing positions may also be verified if they have 3 or more production credits on IMDB, Netflix, Rotten Tomato, Amazon Prime, Hulu, Disney+, or any other major streaming and video platform and have 3 or more featured references from news outlets within a year prior to applying for verification.

Content creators may also be verified if they have consistently published original, engaging content for at least 6 months prior to applying and meeting the criteria.

1.6 Influencers, Community Leaders, and Thought Leaders

These accounts represent people who effectively use social media and their public image to raise social awareness, share information, data, and resources for social action, mobilize and organize communities, and inspire individuals around a cause or social issue to bring about progressive political, cultural, socioeconomic, communal or societal change, or simply change the world. For qualification:

A. Accounts must display a history of abiding by Phaction's Courtesy Policy.

B. Have a history displaying consistent usage of Phaction within six months prior to applying.

C. Does not intentionally advocate for the harm, displacement, maltreatment, and harassment of Phaction users including any and all aspects of violence.

To ensure that fraudulent or suspicious activity does not occur for public roles with high public interest directly or indirectly related to current social issue and events and nonprofit entities, Phaction will also verify accounts based on:

A. Existence in any credible, public index including but not limited to Google Trends, Wikipedia articles that meet their notability standards, and evidence of recent search activity.

B. Public proof or indication of account or account holder leadership for publicized advocacy work.

C. Within the previous six months, the account must be referenced or mentioned by at least three major, notable public sources not limited to official, reputable news entities, reporters, researchers, and journalists including freelancers.

1.7 Legitimacy

The Phaction account must represent, or be associated with, a real person or officially recognized and registered business, organization, nonprofit, or entity.

1.8 Distinction

The account must be the distinct presence of the person, nonprofit, business, organization, or entity it represents. Only one account will be verified per person, business, entity, or organization, with exceptions for nonprofit chapters, location specific entities and language specific accounts. General interest accounts will not receive verification. These accounts include “healthcare” and “police brutality.”

1.9 Activity

The account must be active on Phaction and reflect a history of accordance with the Terms and Agreements. This means:

A. Complete: The account must be public and have a profile picture, origin story or bio, at least one post and at least one completed philanthropic offering.

B. Active Use: The Client must have logged on to your Phaction account within the last six months.

C. Philanthropic Use: The Client must have engaged with a nonprofit or philanthropic offering on Phaction within the last six months.

D. Phaction Courtesy Policy: The account must not have been flagged for violating Phaction Courtesy Policy within the past six months. Successful appeals are excluded.

E. Security: The Phaction account must have a confirmed email address, phone number, and authentic admin with proof of connection to the requested account.

### Philanthropic Prestige Verified Account

To be verified for philanthropic prestige means that Clarintel and Phaction have confirmed that the account represents a legitimate nonprofit entity or individual with confirmed, defensible philanthropic standing. In addition to being verified by their public standing, these accounts must represent Philanthropic Prestige and align with the criteria set by Phaction and Clarintel. Once established, verification will be performed solely by Clarintel, Inc. These accounts are represented with a purple insignia and are public by default. All accounts with this insignia must have 2 or more user accounts associated with this account for security reasons.

### Philanthropic Prestige Verification Criteria

Similar to the public standing account verification, accounts can initiate this process by either selecting the public prestige verification option after creating an unverified account or by visiting the account settings component of their account profile. In addition to the above qualifications for public standing, the account must be approved by Clarintel and satisfy the below criteria

### Philanthropic Prestige

The account represents a prominently recognizable person, business, entity, or organization representing, or associated with the social sector, philanthropic space, nonprofit entities, philanthropic organizations, or foundations.

A. Within the previous six months, the account must be referenced or mentioned by at least three major, notable public sources including, but not limited to official, reputable news entities, reporters, researchers, and journalists.

B. The account must also have publications associated with, referencing, or created by the person, business, entity, or nonprofit, including citations of authored material used by other professionals associated publications.

C. Similar to above, Phaction will utilize Wikipedia articles that meet the notability standards for people and notability standards for organizations and companies to find articles referencing philanthropic and social action related activity.

D. Accounts may also resemble philanthropic prestige by proving that the account or account admin currently or previously held a leadership or board position with a nonprofit entity, foundation, or any other official, credible entity associated with racial equity, philanthropy, public policy, and other racial equity-focused advocacy ventures.

### Friends

All Phaction accounts may be “Befriended.” However, private and verified accounts must accept friend requests while public accounts automatically accept new friends. After befriending an account, the user will automatically receive all real-time updates from the befriended account including posts, shares, reactions, and other notifications in their pheed.

### Champions

Being an account champion on the Phaction App is equivalent to following an account on LinkedIn, only with reduced visibility of account content. By championing accounts, a user only sees content dictated by the championed account. Accounts with a Phaction Insignia such as Public Standing and Philanthropic Prestige Verified accounts can be championed by users. When creating a post, the aforementioned accounts have the option to publish the post to all friends and champions, just friends, or just champions. Unverified accounts cannot be championed. Verified Phaction accounts may be championed by accessing the account profile page. There is no limit to the number of accounts a user can champion, or the amount of champions an account can have.

### 2) DAC & Content Creation

After creating an account, all Phaction Members may immediately begin creating and engaging in a variety of philanthropic and social issue content. All accounts are free to share and discuss feelings, thoughts, and opinions regarding social issues and philanthropy. While unverified and public standing verified accounts cannot create Phaction supported philanthropic resources, they are free to engage and create content supporting credible and legitimate philanthropic entities. Philanthropic Prestige accounts have enhanced privileges for driving change by creating, executing, hosting, and promoting philanthropic opportunities, endeavors, and actions on the Phaction App. Upon receiving Philanthropic Prestige Verification, entities, organizations, and individuals controlling and/or connected to the verified account are 100% liable for philanthropic offerings created, executed, hosted, and promoted on the Phaction App. In addition, all users are responsible for abiding by Phaction Terms and Agreements in addition to Phaction's Courtesy policy.

### Philopics

Philopics, or philanthropic topics, are Phaction's primary method for categorizing all content within the Phaction App. Philopics are color-coded hashtags used to organize platform content and reference all information including, but not limited to philanthropy, social issues, nonprofit, and business philanthropy related topics, geolocations, and other user interests. Each philopic color is determined by Phaction and reflects a specific impact area, such as Police Brutality, Health Equity, and Fair Housing. However, users can enable and create personal philopics using Hashtags, Exclamation Points, and question marks to further organize content for their friends and champions, or specific groups and users. User created philopics will be examined for social issues or philanthropic relevancy via a semantic analysis confirming alignment with Phaction's Courtesy Policy.

Ineligible philopics are any word or phrase representing abusive, violent, hateful, & dehumanizing content; profanity, harassment, nudity, and prejudice including racism, sexism, genderism, ageism, classism, religious bias, disability bias, cognitive bias, and unconscious bias.

Phaction may use third party databases to train artificial intelligence models for the detection of content related to hate speech. Additionally, Phaction may also conduct a sentiment analysis using various Natural Language Processing machine learning algorithm, to analyze the usage of each content item and philopic.

A philopic is considered active if a user publicly mentions or references the philopic within, as only an example, seven days. After, for example, seven days, if a user has not engaged with the philopic, the philopic is considered dormant. After, as only an example, thirty days of no activity or engagement, the philopic is considered inactive.

Philopics are located at the top of each post and controlled by each user. This means that when on a pheed, a user can filter the displayed content and posts based on the available list of philopics. In addition, users will be able to filter all pheed content by any philopic of interest in an active or dormant state; including geolocations, user created philopics, social events and social issues.

### Phaction Pages

A Phaction page is any page not directly representing an individual or entity and created by a Phaction account or the internal Phaction system. Each page is designed differently based on purpose and intended engagement. However, all Phaction Pages consist of common factors such as a public pheed, a philanthropic organizer, page details including related accounts, historical insights, Philanthropic Phruits, and Philanthropic Phlix. These pages will be used to distribute information, data, and resources, both educational and actionable, to other Phaction Accounts. In addition, PhactionPages serve as the means for organizing and centralizing all information, content, thoughts, ideas, insights, and activity regarding a specific digital act of care, social issue, campaign, or philanthropic endeavors. PhactionPages can be championed by all Phaction accounts, but can only be sponsored and created by verified accounts. The types of Phaction Pages Include:

Research Pages: Pages created by Phaction, Clarintel, or any affiliated partners or entities for the purposes of distributing credible content and information to the public. Only verified accounts partnered with Phaction can create these pages. These pages can be attached or included in profiles and other Phaction Pages in the My Phruits portion of the respective profile or page.

Impact/DAC Page: Pages created by Philanthropic Prestige Verified Accounts for the promotion, completion, monitoring and tracking of individual philanthropic opportunities and engagements including but not limited to: charitable giving, petition completion, pledge commitments, web-based events, and volunteer and participation sign ups. These pages are for independent philanthropic offerings and can only be managed by one Philanthropic Prestige Verified Account.

Campaign Pages: Pages created by public standing verified and philanthropic prestige verified accounts that represent joint efforts or partnerships between two or more philanthropic entities or a philanthropic entity and a business entity. Similar to impact pages, Phaction Accounts can also take action through this page. In contrast to single entity management of impact pages, campaign pages can be managed by multiple entities or one entity.

DAC Decks: These are collections of DAC pages created by a single philanthropic prestige account for multiple philanthropic offerings occurring in sequential order. The DAC's contained in DAC Decks are centered around the same cause or social issue and enact change in the same geographical area or towards the same demographic. DAC Decks are managed and controlled by a single philanthropic prestige account and follow the same set up process as DAC Decks with the additional option to add a DAC Page. All DAC Pages within DAC Decks contain identical philopics linking them together.

### DAC Creation Process for Philanthropic Prestige Accounts:

A Philanthropic Prestige Account is the only account with the permission to create DACs for Phaction members to engage with through the Phaction App. A DAC can be created by navigating to the philanthropic organizer and selecting the option for creating a DAC. Following the creation of a DAC, a DAC Page is automatically generated containing the DAC details collected from the managing account. In addition, the managing account is provided with a set of philopics, both general and specific, that can be used to refer to the created DAC, the DAC Phaction Page, and the managing account. Once a DAC is created, key information such as the organizers, managing accounts, program or project plan, goals, DAC time periods, and DAC philopics cannot be changed or edited unless approved by Phaction Account Managers. However, the managing account can edit logistical information such as associated accounts, sponsors, external links, and all description fields. The managing account also has full control over DAC champions and content generated or associated with the DAC. Finally, the managing account is fully responsible for the completion, execution, and fulfillment of all DACs hosted, promoted, or executed on the Phaction. The DAC creation process will be simplified based on previously collected account information including executed DACs. For DAC creation Phaction may utilize information such as, but not limited to: Creator Account Information, Leader Account Information, Change Agent Account Information, Verified Phaction Account Sponsors, DAC name, DAC start date, DAC end date, Donor audience, Participant audience, Target audience, Link to non-profit site, Link to DAC if Outside of Phaction: The associated link must be from the nonprofit site, Facebook, or another philanthropy hosting platform, DAC Action Type for Phaction Hosting, which includes Donations: Philanthropic Prestige Account Associated bank account, Petition: Change.org or Google forms link, Pledge Commitments: Document Upload or link to document location and opt in to one-tap signing for petitions and pledges, Volunteer and Participation Sign Up Forms: opt in to Phaction automated volunteer and participation form completion or attach link to form location.

For DAC creation Phaction may further utilize information such as, but not limited to: Social Issue or Cause and brief description, Description of Desired Impact in relation to social issue or causes, Short Term Goals, Long Term Goals, Philopics for DAC, Reasoning for philopic if created or not directly affiliated with the social issue or cause, and Additional DAC Details: Text Box—1000 characters or less.

### DAC Deck Creation Process

To create DAC Decks, Philanthropic Prestige accounts can simply link DACs together by selecting a button on a DAC Page. Once selecting this option, accounts are provided with a list of similar DACs determined via a semantic analysis of DAC information performed by artificial intelligence models. If the DAC is not listed, the account is given the option to add the missing DAC from a separate list of active DACs. This selection must be approved by a Phaction Staff member before DAC linkage occurs. Once DAC's are linked, they will be displayed in the accounts philanthropic organizer as stacked pages, or Decks. These pages will be automatically ordered based on end date, meaning that the earliest end date receives the priority over other DAC pages. In regards to sponsorship, individual DACs within a DAC Deck can be sponsored in addition to the entire DAC Deck.

### Campaign Initiation Process

Campaigns are joint efforts or partnerships between two or more philanthropic prestige accounts or between philanthropic prestige accounts and public standing accounts. For all Campaigns, at least one Philanthropic Prestige Account must participate for the campaign to be approved and hosted on the Phaction App. For Campaign creation, Philanthropic Prestige accounts must first navigate to the philanthropic organizer and create a DAC. After creating a DAC successfully, philanthropic prestige accounts are given the option to add other verified Phaction accounts to assist with the DAC outside of sponsorship. Once initiating a campaign partnership, a campaign request is sent to the respective entity. Following the acceptance of the campaign request by a verified account, a Campaign page is automatically generated containing default DAC information and detailed information regarding both entities. In addition to DAC information above, verified accounts looking to host a campaign must provide: Detailed reasoning for partnership, Partnership Goals and Expected Outcomes, Theory of Change aligning with Phaction Change Tracking Measures, Project Plan for DAC including work delegation per entity, and Management splits for partnerships.

### Sponsored Organizations

On the Phaction App, verified accounts can show public support for philanthropic endeavors and publicize partnerships through campaigns and sponsorships. Campaigns are ongoing philanthropic offerings in the form of publicized partnerships and philanthropic ventures between multiple philanthropic prestige accounts or philanthropic prestige and public standing accounts. These are organized and created by philanthropic prestige verified accounts, but can be initiated via philanthropic prestige account profile pages by any verified accounts.

In addition, all verified accounts have the ability to sponsor philanthropic prestige accounts. When a verified account sponsors a philanthropic prestige account, the verified account is granted increased platform visibility for posts and content referring to, associated with, or mentioning the sponsored account and related DACs. To sponsor an account, the public standing verified account sends a sponsor request to the philanthropic prestige verified account. Once the Philanthropic Prestige verified account accepts the request, the sponsored account is displayed in the public standing verified accounts profile. These sponsorships have no set time limit and can be terminated at any time by either account.

### Sponsored DAC's and Sponsored DAC Decks

Similar to above, verified accounts can send a request to sponsor DAC's Pages and DAC Decks through the respective Phaction Pages. Sponsorships for DACs and DAC Decks only last for the duration of the respective offerings. During this time, sponsorships can be terminated at will by either account. Accounts that are selected for sponsorship are displayed on the respective DAC Page or on each DAC Page within the DAC Deck.

### Phaction Invites

All Phaction Members have the ability to invite individuals to join the Phaction App community. Individuals can send invites at any time by navigating to the notification panel on the Phaction App and selecting the “invite users” option. Similar to above, invites can be sent through mediums including, but not limited to: SMS, Text, iMessage, Email, Facebook, Twitter, Instagram, Tik Tok, Reddit, and other social media and blog platforms.

### Phaction DAC Invites

When an account shares a DAC to an individual that does not have a Phaction Account, the individual is first sent a Phaction Invite. After completing the Account Creation Process, the individual is able to access the DAC invite from both their notification panel and their philanthropic organizer. If an individual already has a Phaction Account, then they are sent a notification of the DAC invite and the invite is added to their philanthropic organizer. Once selecting the DAC, the account is directed to the respective DAC page for engagement. After completing DAC engagement, the user that sent the invite is sent a notification of the completed engagement for the purpose of displaying support and/or gratitude for the completed DAC.

### 3) DACs, Social Action, & Feedback Loops

In addition to the above capabilities, Phaction may provide multiple ways to create, share, and interact with all Phaction members. Through posts, comments, gestures, mentions, shares, pheeds, mentions, and additional features, Phaction members can truly revolutionize the world of philanthropy and fight social issues like never before.

### Posts

Phaction Posts provide each user with a means to share their thoughts, ideas, truth, empathy, story, and support with others regarding philanthropy and social issues. Each post type below allows users to express themselves freely and creatively. Though explained as one below, a post is separated into 2 sections, a Text Segment and a Media Segment. The Text segment contains all text of a Phaction Post. The media portion of a Phaction Post allows users to attach diverse media including but not limited to: Phaction Pages, photos, videos, documents, files, pheels, datasets, and data visualizations. Unless otherwise noted, a user can react via gestures, comment, share, or save any post type below.

Text Based Posts—Posts that contain either text only, text and photos, or text and videos. For posts with videos and photos, text is optional.

Impact Posts—Posts associated with Impact Pages that allow users to engage in any multifaceted philanthropic action. From this post, a user can easily donate, sign a petition or pledge, and sign up for a philanthropic opportunity given a tap or a swipe. These posts will be designed differently from other posts to amplify philanthropy.

Activity Posts—Posts pertaining to friend and champion activity outside of created posts. These types of posts include reactions to content, comments, philanthropic engagement, and other interactions of friends with app content. When users react or comment on this post, they are reacting to the content engaged with by the respective friend or champion.

Shared Posts—a post consisting of content shared to Phaction from external entities or another Phaction Account.

Community and Personal Posts—Posts from a user where post visibility is restricted to specific friends and champions or to the individual user.

Post Deck—A combination of 2 or more of the above post types to create 1 post. The post decks representing campaigns and DACs will be designed differently from other posts to amplify philanthropy.

DAC Posts: Posts generated by the system once a user takes action or engagees with a philanthropic offering or DAC. The posts are visible to all friends and champions. These posts will be designed differently from other posts to amplify philanthropy.

AutoGenerated Data Posts: Posts generated by the system based on user geolocation that builds philanthropic and social issue insights given interest, recently viewed content, and available datasets and information found in Phaction.

AutoGenerated Captions for Posts: During creation, accounts can enable caption auto generation to streamline caption creation. The account can select a set of words, topics, and/or philopics from which the caption will be framed. The caption will be built using a Natural Language Processing Artificial Intelligence model, or other AI/ML model, trained on existing captions and related phrases created and used by individuals when discussing social issues and philanthropy. Phaction Members can auto generate as many captions as needed and change the wording of any auto generated caption.

### Post Comments and Gestures

In Phaction, a comment is defined as any written reply to a Phaction post. Likewise, we define a gesture as any digital reaction to a post taken by one account in support or acknowledgement of another account not including comments.

Gestures may be used to represent user actions such as instant DAC's, and emotions such as, but not limited to, joy, daps, handshakes, high fives, waves, attraction, enjoyment, top preferences, unsureness, surprise, shock, flattery, emojis, bitmojis, and gifs. This also includes gestures for showing interest or non-interest for nonprofit engagement.

For Comments and Gestures, the below criteria apply to all Phaction Accounts:

1. For all private accounts, post interactions (comments and gestures) are restricted to friends and champions.

2. Anyone can view public account comments and gestures.

3. Comments and gestures made by private accounts to public content are visible by all Phaction accounts.

4. All Phaction accounts can comment and react to any public post or Phaction Page not directly associated with a user account such as a user profile page.

5. Users will be able to enable the option for sending contact information to nonprofits upon following the nonprofit entity or reactions to specific nonprofit offerings such as programs, initiatives, action, events, or any nonprofit content. For championed nonprofits or user-reacted philanthropic offerings, contact information will only be sent to nonprofits registered on Phaction's Platform and vetted by Clarintel and Phaction. All other follows will be regulated via user platform restrictions.

6. For championed nonprofit entities, contact information will be sent for any assistance needed by a nonprofit at any time for any event. In this case, nonprofit outreach is broad, general, and unlimited.

7. For reactions to specific nonprofit offerings or published content, user contact information will only be sent for the purpose of the offering or post unless otherwise mentioned by the user via the user profile. In this case, nonprofit outreach is limited unless otherwise mentioned by the user.

8. User contact information includes, but is not limited to: phone number, email address, social media account, or any other form of contact necessary for nonprofit outreach.

9. All gestures are shown publicly for public and verified accounts.

Post Mentions

A user can be mentioned or referenced in any Phaction Post using the @ symbol. The criteria for post mentions are:

1. Any public, verified, nonprofit, and business account can be mentioned by any user.

2. Private accounts can only be mentioned by Friends.

3. All accounts receive a notification for received posts.

4. All users have the option to restrict post visibility to certain users per post. This is also known as community posting.

### Reposts

All content on Phaction is displayed in the form of a post. Users can share existing posts on the platform as they are or they can share content as their own with the creating account tagged within the post. When sharing a post, if the post is unedited, then any engagement is recorded on the original post. If the post is edited when shared, then the post engagement metrics reset and the edited shared post is displayed as a new post.

### Clarintel Shares to Phaction

Content shared from Clarintel to Phaction by Clarintel partners will be shared through a special post both tagging and promoting Clarintel. This specialized post type will be a different color representing Clarintel, contain the associated link, tagline or headline, and a brief description, and reference the Phaction Account. This specific post type will be expanded more during development.

### External Content Shares as Links to Phaction

All accounts can share external content to Phaction in the form of a link or URL. Phaction may also create a sharing API that external entities can use to streamline the sharing process for individuals with Phaction Accounts. All links will be scanned for security threats before posting.

### Phaction Content Shared as Link to External Entities

Phaction content can be shared to external entities as a link or URL. Phaction will utilize API's and partnerships with third party entities to streamline the sharing process to external entities. Phaction will also allow users to connect social media accounts to their Phaction profile for easier content sharing and management. Individuals outside of Phaction can preview shared content on third party entities, but can only view content on the Phaction App after creating an account and becoming a Phaction Member. Shares containing Phaction Content will redirect viewers to the Phaction App for content engagement. Phaction content can be shared through mediums including, but not limited to: SMS, Text, iMessage, Email, Facebook, Twitter, Instagram, Tik Tok, Reddit, and other social media and blog platforms.

### Phaction Boards Shared to External Entities

For inclusion in web pages and websites, Phaction will allow members to export individual Phaction Posts as Phaction Boards. Additional insights will be provided for this type of share.

### Share Phaction Content Via QR Codes

Phaction will both create and allow members to create and manage QR codes for sharing philanthropic opportunities, resources, and content with one another. All QR codes will be stored by Phaction and accessible via the members profile page.

### Share Phaction Content Based on Proximity

Phaction will provide the capabilities for members to opt-in to sharing and receiving Phaction content based on proximity to another Phaction member. Phaction will utilize partnerships with external companies and services prior to enabling this feature. The content shared based proximity includes, but is not limited to philanthropic opportunities within a specific range of the Phaction members and philanthropic or social issue content of interest.

### Pheeds

The Pheed, or Philanthropic Feed, is a type of social media feed that encompasses all user activity outside of confidential and sensitive user information (or anything deemed as private by the user). On Phaction, the pheed consists of a collection of organized posts. The below information is some of the information that will be displayed publicly for users to view.

Friend Activity: Users will be able to see all friend philanthropic activity including but not limited to reactions to platform content, shares (without recipient), goal setting and accomplishments, team/group creations and milestones, amount of lives impacted as a friend base, team/group, and individual, and all other activity showing philanthropic engagement.

Championed Account Activity: Information will be selectively shown to users based on championed account preference. The user will be able to view all followed account information via the accompanied profile page. Activity shown by default includes, but is not limited to: followed account reactions by other influencer and accredited accounts, highlighted engagement by followed accounts, followed account philanthropic endorsements, etc.

Philanthropic Action & Nonprofit Updates: Once a user participates in a nonprofit offering, they “subscribe” to or follow the nonprofit account. The nonprofits' philanthropic updates and alerts are then added to the user's philanthropic feed. Users can opt-out of this feature at any time.

Trending Nonprofits and Social Issues based on: geolocation, social issues and nonprofits of interest, philanthropic offerings of interest, philanthropic engagement preferences, and other factors determined following further development.

Research: Clarintel will provide Phaction with specific verified research content related to specific philopics including but not limited to data visualizations, geographic-focused philopic updates, and social issue report files and documents, that will be displayed in pheeds as the user scrolls.

### Pheed Types

Landing Pheed—The Landing pheed is the primary user pheed and contains all content based on user interest, engaged nonprofits, followed and friended accounts, and other factors determined upon further development.

Search Engine & Explore Pheed—The Explore Pheed allows users to discover opportunities outside of their interest or communities. The explore pheed is the face of Phaction's search Engine and allows users to search for and filter content by any philopic including Social Issue, Nonprofit, Campaign, Geographical Location, Time Period, and Philanthropic venture. Users can also search for other accounts, entities, and organizations.

Impact Pheed—The Impact Pheed contains all content referencing credible philanthropic and social issue news and information. The information on this pheed will pertain to systemic racism; initially beginning with Police & Prison Reform, Health Equity, Voter Equity, and Fair Housing.

Instant Action & DAC Pheed—Phaction allows users to easily access actionable resources via the Digital Act of Care, or DAC, Pheed. This pheed contains all active philanthropic offerings sorted based on user interest, geolocation, and philopic.

### Direct and Group Message

Phaction provides all accounts with the ability to share thoughts, ideas, emotions, truth, and experiences with each other depending on user account settings. Phaction allows users to comment on, react, and respond to posts, tag each other in comments and posts, and send messages privately to one another and to groups of friends or champions. The types of conversations between Phaction accounts and governing regulations are below.

In Phaction, a direct message is a message sent between two users. The criteria for direct messages are:

A. All accounts have an inbox for receiving direct and group messages.

B. Private accounts can receive messages in the form of message requests.

C. Public accounts can receive direct messages sent by any Phaction Account.

D. Nonprofits, business and verified accounts can receive direct messages from friends and champions, and other verified nonprofit and business accounts. Public user accounts that are not friends or champions of the aforementioned accounts are segmented at the verified entities designation to create differentiations within direct message senders.

E. Upon receiving a direct message, all accounts receive a notification of the new message.

### Pheels, Phlix, and Phruits

Phaction members can further reinvent the way philanthropic and social issue information is shared through Pheels, Phlix and Phruits. These are Phaction-created approaches for representing and organizing different types of shareable platform content. All Phaction members can create these content types and have full control over the visibility of each. By default, this content is public for public and verified accounts. All public content is liable to appear on the Explore page for account engagement. For private accounts, visibility is limited to friends. The details of Pheels, Phlix, and Phruits are below:

Pheels: Phaction allows users to share live and recorded videos on the App through Pheels, or Philanthropic Reels and Stories. Pheels are live or recorded videos, not shared through posts, that represent social issues or philanthropic ventures. Members can view all pheels at the top of the home pheed. Recent Pheels will be positioned within the home pheed for account viewing. In addition, Phaction members can view pheels by tapping the account profile photo. Pheels tagged with philopics will also be searchable from the explore page and certain pheels tagged with philopics will be spotlighted on the Explore Pheed for additional account engagement. Pheels saved by the account holder, whether created or not, can be found in the account profile under the “My Pheed” and “My Pheels” pheeds. Live or Posted pheels that are not saved to Phaction accounts will expire and become unretrievable after 24 hours.

Phlix: Phlix are videos, photos, gifs, and other media forms shared on the Phaction App via a post. All Phlix posted by Phaction Members in a post are saved in the account profile under the “My Pheed” and “My Phlix” pheed. Phlix follow the same criteria as Posts. Before posting, all uploaded phlix will be examined for security threats. A record of all phlix posts will be saved in the creating accounts “My Plix” component and does not expire unless deleted by the account holder.

Phruits: Phruits are documents, files, voice recordings, podcasts, reports, and autogenerated analytical visualizations, or digi-phruits (discussed below) shared via a post. Similar to above, these follow the same criteria as Posts. Phruits saved and created by the account holder can be found in the account profile under the “My Pheed” and “My Phruits” components. Before posting, all uploaded phruits will be scanned for security threats and fraudulent behavior.

### Digi-Phruits: Real-Time Data Visualizations

Phaction will provide all members and accounts with the ability to visualize any stored or uploaded data set, file, document, insight, or any offered platform metric in real time. The data visualized will be stored in the form of a Phruit (discussed above) that users can include in any post type for sharing. Created digi-phruits can be found within the “My Phruits” section of the Account Profile. In addition, a copy of phruits associated with specific DACs or with philanthropic activity will be stored in the philanthropic organizer. Digi-Phruits can be directly created from the philanthropic organizer, or indirectly created at any time given previously engaged and currently available content displayed on pheeds. Data visualizations will be created using tools such as, but not limited to, Grifana, Kibana, and Tableau.

### 4) Account & DAC Management

Each Account is provisioned a profile for maintaining a record of all user generated app activity. Profiles are segmented into 4 sections: the account bio, private pheeds, the philanthropic control center, and the philanthropic organizer.

### Account Bio

The user information shown in the account bio will resemble the information collected in the first part of the sign-up process. In addition, the user will have the ability to upload a profile image, to choose philopics to spotlight in the user bio, to upload philanthropic videos and voice recordings, and to write a bio or origin story detailing their philanthropic journey, affiliation with nonprofit organizations and entities, or stance against a social issue. Accounts can also connect their LinkedIn account to their Account Bio for occupation showcases and industry credibility.

### Private Pheeds

The pheed displayed on the user profile page will resemble the home pheed, but only contain content created, reposted, commented on, or shared by the user. This also includes content where the user is tagged or mentioned. The Private Pheed section has four components or filters: My Pheed, My Phlix, My Phruits and the Safe Space. Each pheed will be filterable by user chosen philopic.

My Pheed—all content posted or reposted by the account holder. This includes comments, shares, and all content associated with the user via tags or mentions. This does not include user gestured content. The types of content shown on this pheed includes DACs, posts containing text, photos, videos, podcasts, links, documents, files, and impact pages.

My Phlix—all philanthropic or social issue related pictures and videos posted, reposted, or saved by the user. This includes all pictures or videos associated with the user via tags or mentions. The type of content shown in this pheed is limited to posts containing photos and videos.

My Phruits—all voice recordings, podcasts, files, or documents created, engaged with, or saved by the user. This includes all voice recordings associated with the user via tags or mentions. The type of content shown on this pheed is limited to posts containing documents, files, voice recordings, and podcasts.

The Safe Space—Phaction allows accounts to post content for their own record, only accessible and visible to themselves. The Safe Space provides accounts with privatized microblogging in which this space is fully controlled and managed by the user. Users are provided with the option to completely privatize the safe space or invite less than 10 people to share your safe space with you. When creating a post, users have the option to make a post private. When posts are set to private, they are automatically added to the Safe Space and can be seen only by the user and whomever the user may invite.

### My Philanthropy—The Philanthropic Organizer

This feature is the public facing version of the PCC discussed below. Coined as “My Philanthropy,” this profile segment shows an overview of all account philanthropic activity taken since first joining Phaction. The information shown for the section differs depending on the accounts verification status, but is controlled entirely by the user. The information shown in this section will be a summary of the information shown in the account specific PCC detailed below. After engaging with any DAC on the Phaction App, the DAC and associated information will be added to My Philanthropy. This includes saving DACs for later engagement.

### The Philanthropic Control Center (PCC)

This feature is included in all accounts and only accessible by the account holder. Each account verification has a different philanthropic control center with varying capabilities. The philanthropic control center provides users with the ability to organize, manage, track, and execute all philanthropic actions or ventures hosted on the Phaction App. In addition, the PCC also includes audience insights for a deeper understanding of an individual's philanthropic influence and reach. The PCC is accessible through the “My Philanthropy” section of the user profile. The different PCCs provided to each account are:

### PCC for Unverified Accounts

Unverified accounts are only able to interact with philanthropic offerings on Phaction. They are not able to create or sponsor individual philanthropic opportunities or campaigns. The Philanthropic Control Center for Unverified accounts allows users to: (1) Organize, schedule, and manage all philanthropic opportunities in multiple formats including calendar, time, and list based, (2) Set alerts and reminders for philanthropic opportunities, (3) Prioritize philanthropic entities, ventures, and engagements and set specific signals and triggers for notifications and alerts, (4) Understand the depth of philanthropic offerings and individual contributions beyond surface level impact. For example, instead of just showing users how much money they donated, Phaction will show users exactly what their money was spent on and the amount of lives reached based on the individual's contribution. Other Metrics used to demonstrate individual philanthropic involvement include the ones discussed above in “My Philanthropy,” (5) Understand audience engagement with a variety of User Audience Insights and metrics including, but not limited to: Impressions, Interactions, Philanthropic Influence, Social Influence, and Philanthropic Reach, (6) Set up and edit recurring donations for philanthropic offerings and entities, (7) Edit, enable, or disable signatures necessary for pledge commitments and petitions, (8) Provide any information needed to complete volunteer, participant, and attendee sign up forms, (9) Other metrics related to tracking the progress of all philanthropic offerings, and (10) Manage recurring donations and donations to individual entities or philanthropic offerings.

### PCC for Public Standing Verified Accounts

Unlike unverified accounts, public standing verified accounts can sponsor Philanthropic Prestige accounts and associated offerings hosted on the Phaction App. Details on sponsorship can be found in the above section under Campaigns & Sponsorships. In addition, these accounts have advanced capabilities compared to unverified accounts with additional insights for understanding their audiences, campaigns, sponsorships, and philanthropy through engagement, impressions, reach, and other forms of philanthropic activity. The PCC for public standing verified accounts provides the ability to organize, manage, and enhance personal and network philanthropic activity.

### PCC for Philanthropic Prestige Verified Accounts

In addition to the above capabilities, Philanthropic Prestige Verified Accounts have the unique ability to create philanthropic opportunities for users to engage in. These philanthropic opportunities, or DACs, will be created and promoted through Phaction Pages once proving alignment with Phactions Theory of Change and Phaction's Terms and Agreements. The types of philanthropic opportunities that a Philanthropic Prestige Verified Account can promote through Phaction include, but are not limited to: petitions, pledges, all charitable giving and fundraising ventures, and all sign up opportunities, both virtual and physical. These types of accounts receive metrics and insights regarding their audiences as well as their individual philanthropic engagements and DACs. Through the PCC, these accounts can manage all accounts linked to fundraising opportunities and track marketing and promotion strategies taken via Phaction for multiple offerings all in one place.

### Philanthropic Roles and the Points & Levels Based System

As a member comes on the platform, they can select a role representing their philanthropic identity. The philanthropic role is a public indicator of presumed philanthropic activity based on an individual's preferred activities or interests. All philanthropic roles are independent from one another and individuals can alternate between philanthropic roles at any given time. These roles will be portrayed with different colors and the platform experience will reflect the appropriate color based on the selected role. Philanthropic Role upgrades will occur through a points and levels based system. Within this system, member accounts can increase their status or level within each role by executing a set of point-based philanthropic tasks in which the points associated with the completed tasks equals or exceeds the amount set by Phaction Leadership. Once an accounts level reaches a certain amount, the accounts philanthropic role will be upgraded and the levels reset to 1. Phaction will start with the below philanthropic roles and schema for the points and levels-based system and intends to continuously make enhancements through consumer studies and development.

### Points and Levels Based System

Phaction will create and publicize guidelines and benchmarks for completing tasks and increasing levels respective to individuals current philanthropic role and level. Initially, Phaction will provide individuals with a list of 100 tasks from which a certain number of points must be completed to increase their philanthropic level. The amount of points needed to achieve the next level and effort of each task will increase as the accounts level increases in respect to the current philanthropic role. All tasks will be executable via the Phaction App and are related to philanthropy and social action. Philanthropic roles will be initially increased based on the following awards scale: bronze, silver, gold, diamond, platinum, black platinum. Specific levels and points for each philanthropic role will be determined following further research, development, and field studies. When determining levels, Phaction will take into account the below factors:

A. Phaction publication of philanthropic endeavors with mention or inclusion of a verified account. This includes all partnerships initiated and publicised through the Phaction App.

B. Philopic Usage including frequency, diversity, and amount.

C. External interaction and engagement generated from original content, DAC Activity, and other forms of authentic philanthropic activity.

D. Frequency and diversity of philanthropic engagement and content including, but not limited to: shares, posts, DACs, comments, gestures and invites.

E. Feedback Loop saturation and outcomes including empathy and support shown and received through the Phaction App.

### Philanthropic Roles

Phaction will allow members to select Philanthropic Roles in three ways. Accounts can either select their Philanthropic Role manually, automatically match to a philanthropic role after completing a Myers Briggs personality test, or match to a philanthropic role by selecting a role model. This approach will be expanded to include account occupation and life path numbers. All philanthropic roles contain independent tasks requirements and levels to complete for role and level upgrades. Phaction members can only hold one philanthropic role at a time and all philanthropic roles are publicly displayed in the members profile and philanthropic organizer. In addition, tasks do not “carry over” from one phlanthoropic role to another.

| Philanthropic | Personality | Main Personality | Philanthropic | | | | Superpower |
|---|---|---|---|---|---|---|---|
| Role Category | Type Category | Type | Role | Role Description | Occupation | Superpower | Description |
| Default | — | — | Explorer | | | | |
| Scholars | Analyst | INTJ | Utopian | Intelligent and | Musical | A.I.R | The ability to |
| | | | | unrelenting, this | Performer, | (Architecting | create long |
| | | | | superhero | Managing | Idealistic | lasting |
| | | | | works hard to | Editor, | Reformation) | change |
| | | | | get things done. | Photographer, | | powered by |
| | | | | They thrive on | Financial | | strong ideals |
| | | | | knowledge and | Advisor, | | and a natural |
| | | | | constantly | Marketing | | ability to |
| | | | | search to | Manager, | | transfer their |
| | | | | understand and | Teacher, | | sense of |
| | | | | absorb more | Physical | | moral |
| | | | | information. | Therapist | | responsibility |
| | | | | They tend to | | | and idealism |
| | | | | use logic and | | | to others. |
| | | | | reason when | | | These |
| | | | | helping | | | powers birth |
| | | | | someone and | | | monumental |
| | | | | generously use | | | ideas and |
| | | | | their knowledge | | | initiatives at |
| | | | | to build | | | will, that |
| | | | | communities | | | cannot be |
| | | | | and societies. | | | changed or |
| | | | | This superhero | | | destroyed. |
| | | | | never backs | | | |
| | | | | down from a | | | |
| | | | | challenge, and | | | |
| | | | | does everything | | | |
| | | | | in their power to | | | |
| | | | | bring their | | | |
| | | | | ideals to life. No | | | |
| | | | | matter what, | | | |
| | | | | this superhero | | | |
| | | | | believes that | | | |
| | | | | the best can be | | | |
| | | | | better. | | | |
| Scholars | Analyst | ENTJ | Dr. Scope | Driven, | Business | Emorph | The ability to |
| | | | | Intelligent, and | Administrator, | | instantly |
| | | | | Focused on the | Public | | change their |
| | | | | Future, this | Relations | | energy and |
| | | | | superhero | Specialist, | | empathize |
| | | | | strives to | Mechanical | | based on the |
| | | | | understand the | Engineer, | | information |
| | | | | world around | Judge, | | and |
| | | | | them and | Construction | | emotions of |
| | | | | expand their | Manager, | | those |
| | | | | mind in any way | Astronomer | | around. |
| | | | | possible. Dr. | | | Extremely |
| | | | | Scope feels | | | useful for |
| | | | | responsible for | | | forming |
| | | | | those around | | | meaningful, |
| | | | | them and is | | | long lasting |
| | | | | dedicated to | | | connections |
| | | | | helping all | | | |
| | | | | things reach | | | |
| | | | | their highest | | | |
| | | | | potential, no | | | |
| | | | | matter how big | | | |
| | | | | or small. Born | | | |
| | | | | between the | | | |
| | | | | known and | | | |
| | | | | unknown, Dr. | | | |
| | | | | Scope is | | | |
| | | | | extremely | | | |
| | | | | curious and | | | |
| | | | | intuition | | | |
| | | | | heightens their | | | |
| | | | | thirst for theory, | | | |
| | | | | complexity, | | | |
| | | | | insight, and | | | |
| | | | | vision for long | | | |
| | | | | range | | | |
| | | | | possibilities and | | | |
| | | | | outcomes. Their | | | |
| | | | | ability to | | | |
| | | | | authentically | | | |
| | | | | read, respect, | | | |
| | | | | and relate to | | | |
| | | | | others allows | | | |
| | | | | them to find the | | | |
| | | | | perfect balance | | | |
| | | | | between logic | | | |
| | | | | and empathy. | | | |
| Scholars | Analyst | INTP | Cerebro | As an | Composer, | Mind Mag | Through |
| | | | (The Brain) | independent, | Professor, | | intense |
| | | | | analytical | Writer, | | concentration, |
| | | | | problem solver, | Producer, | | powerful |
| | | | | Cerebro prefers | Biomedical | | thoughts |
| | | | | to work | Engineer, | | explode |
| | | | | alone. Taking | Marketing | | through the |
| | | | | time to detach | Consultant, | | mind of |
| | | | | and logically | Web | | whoever is in |
| | | | | process all | Developer | | reach. This |
| | | | | aspects of a | | | power |
| | | | | situation is key | | | causes |
| | | | | to the role of | | | individuals to |
| | | | | Cerebro. After | | | be thoughtful |
| | | | | solving | | | and honest; |
| | | | | problems, | | | and has also |
| | | | | Cerebro shocks | | | been seen to |
| | | | | all by providing | | | dramatically |
| | | | | a concise | | | increase |
| | | | | analysis of an | | | awareness. |
| | | | | idea or | | | |
| | | | | situation. They | | | |
| | | | | will always ask | | | |
| | | | | difficult | | | |
| | | | | questions and | | | |
| | | | | challenge | | | |
| | | | | others and | | | |
| | | | | themselves to | | | |
| | | | | find innovative | | | |
| | | | | logical | | | |
| | | | | approaches that | | | |
| | | | | will shake the | | | |
| | | | | world. | | | |
| Scholars | Analyst | ENTP | Dream | Motivated by | Attorney, | Dream | The ability to |
| | | | Rider | the simple | Copywriter, | Surfing | traverse |
| | | | | question: “What | Financial | | multiple |
| | | | | If?”, The | Planner, | | dreams and |
| | | | | Dream Riders | Psychologist, | | quickly |
| | | | | are intelligent, | Systems | | explore |
| | | | | enthusiastic | Analyst, | | hundreds of |
| | | | | people who | Creative | | possibilities |
| | | | | thrive on | Director, | | and |
| | | | | possibilities. | Operations | | outcomes all |
| | | | | The desire to | Specialist | | at once. |
| | | | | explore allows | | | Because of |
| | | | | the dream rider | | | this power, |
| | | | | to reach into the | | | they have |
| | | | | depths of the | | | the keen |
| | | | | universe and | | | ability to |
| | | | | find ideas that | | | create |
| | | | | transform, | | | solutions that |
| | | | | improve, and | | | bring |
| | | | | change the very | | | communities |
| | | | | world around | | | together. |
| | | | | them. As natural | | | |
| | | | | leaders that | | | |
| | | | | fearlessly dive | | | |
| | | | | into each | | | |
| | | | | possibility, they | | | |
| | | | | intuitively | | | |
| | | | | understand how | | | |
| | | | | to unite and | | | |
| | | | | enhance the | | | |
| | | | | strengths and | | | |
| | | | | creativity of the | | | |
| | | | | people around | | | |
| | | | | them. | | | |
| Guardians | Sentinels | ISTJ | The Eye | With | Dentist, | Unveil | The ability to |
| (The Watch) | | | | unwavering | Certified Public | | see what |
| | | | | focus, the Eye | Accountant, | | others miss, |
| | | | | sees what | Supply Chain | | ignore, or |
| | | | | others can't and | Manager, | | otherwise |
| | | | | therefore, they | Business | | cannot see. |
| | | | | often do what is | Analyst | | At any point |
| | | | | necessary, | | | in time, |
| | | | | but not easily | | | visions |
| | | | | understood. As | | | appear |
| | | | | the superhero | | | based on |
| | | | | that is reliable, | | | intellectual |
| | | | | steady, and | | | insight |
| | | | | supportive, they | | | driving |
| | | | | help us track | | | change and |
| | | | | the world and | | | impact to |
| | | | | keep things | | | those in |
| | | | | moving. | | | reach. |
| Guardians | Sentinels | ESTJ | Intel Agent | Ambitious and | Judge, Coach, | Community | The ability to |
| (The Watch) | | | | results driven, | Financial | Cultivation | immediately |
| | | | | this superhero | Officer, Hotel | | identify, |
| | | | | is someone you | Manager, Real | | understand, |
| | | | | see everyday, | Estate Agent | | and adapt to |
| | | | | and may not | | | any situation |
| | | | | even realize it. | | | and |
| | | | | As your friendly, | | | environment. |
| | | | | community Intel | | | Once |
| | | | | Agent, you can | | | initiated, |
| | | | | trust that this | | | those within |
| | | | | superhero will | | | reach |
| | | | | always be there | | | become |
| | | | | to do what's | | | more |
| | | | | right. This | | | empathetic |
| | | | | superhero uses | | | towards one |
| | | | | all experiences | | | another. |
| | | | | to analyze their | | | |
| | | | | environment | | | |
| | | | | and produce | | | |
| | | | | immediate, | | | |
| | | | | visible, and | | | |
| | | | | tangible results. | | | |
| Guardians | Sentinels | ISFJ | The | Caring, | Accountant, | Deep Root | Protecting |
| (The Watch) | | | Defender | compassionate, | Financial | | and |
| | | | | and extremely | Clerk, Bank | | defending |
| | | | | understanding, | Teller, | | those |
| | | | | the defender | Research | | fighting for |
| | | | | stands for all | Analyst, | | change by |
| | | | | and sacrifices | Accountant, | | detecting the |
| | | | | none. They are | Administrative | | root of all |
| | | | | inevitably pulled | Manager, | | issues |
| | | | | to help | Photographer, | | affecting |
| | | | | everyone and | Elementary | | systems, |
| | | | | cannot resist | Teacher | | societies, |
| | | | | the chance to | | | and |
| | | | | make an | | | individuals |
| | | | | impact. The | | | and |
| | | | | Defender often | | | providing |
| | | | | places the | | | powerful |
| | | | | needs of their | | | emotional |
| | | | | community | | | and |
| | | | | above their own | | | analytical |
| | | | | and takes the | | | support. |
| | | | | responsibilities | | | |
| | | | | of their | | | |
| | | | | communities | | | |
| | | | | seriously. As | | | |
| | | | | extremely good | | | |
| | | | | listeners that | | | |
| | | | | think in complex | | | |
| | | | | and nuanced | | | |
| | | | | thoughts, they | | | |
| | | | | understand the | | | |
| | | | | human | | | |
| | | | | condition and | | | |
| | | | | can help people | | | |
| | | | | in unimaginable | | | |
| | | | | ways. | | | |
| Guardians | Sentinels | ESFJ | The | Loving, Loyal, | Office | Instant | The ability to |
| (The Watch) | | | Harmonizer | and generous, | Manager, | Transmission | transfer |
| | | | | harmonizers | Technical | | ideas, data |
| | | | | freely give all of | Support | | and thoughts |
| | | | | themselves for | Specialist, | | to those |
| | | | | the communities. | Museum | | within range |
| | | | | They strongly | Curator, | | that brings |
| | | | | believe that life | Psychologist, | | people |
| | | | | is about | Medical | | together and |
| | | | | connection and | Researcher | | boost the |
| | | | | support and do | | | likelihood |
| | | | | all they can for | | | of creating |
| | | | | people, | | | practical |
| | | | | obsessing | | | solutions that |
| | | | | over the needs | | | dramatically |
| | | | | of others. | | | improve the |
| | | | | Harmonizers | | | lives of those |
| | | | | are extremely | | | impacted. |
| | | | | strategic with | | | |
| | | | | allocating their | | | |
| | | | | resources and | | | |
| | | | | always find the | | | |
| | | | | ability to bring | | | |
| | | | | others together. | | | |
| Ambassador | Diplomats | INFP | Cyborg | Cyborgs | Copywriter, HR | Social Mining | The ability to |
| | | | | realized long | Manager, | (Interpretation | analyze any |
| | | | | ago that they | Physical | and | and all data, |
| | | | | are meant for a | Therapist, | Decoding) | information, |
| | | | | greater purpose | Mental Health | | and |
| | | | | and often | Professional, | | situations no |
| | | | | become lost in | Artist, | | matter the |
| | | | | the thought of | Photographer | | complexity |
| | | | | what needs to | | | and instantly |
| | | | | be changed in | | | measure the |
| | | | | the world, | | | success of |
| | | | | including every | | | each |
| | | | | possible way to | | | outcome. |
| | | | | ensure a | | | Those within |
| | | | | positive | | | reach |
| | | | | outcome. Wired | | | immediately |
| | | | | to maintain | | | obtain |
| | | | | strong inner | | | knowledge |
| | | | | morals, | | | and insights |
| | | | | Cyborgs also | | | needed to |
| | | | | love to explore | | | change the |
| | | | | all perspectives, | | | world. |
| | | | | analyze the | | | |
| | | | | potential and | | | |
| | | | | feasibility of all | | | |
| | | | | aspects of | | | |
| | | | | humanity, and | | | |
| | | | | are deeply | | | |
| | | | | invested in | | | |
| | | | | anything | | | |
| | | | | peaking their | | | |
| | | | | interest. | | | |
| Ambassador | Diplomats | ENFP | The Spirit | The Spirit is | Reporter or | Clairsentience | The ability to |
| | | | | deeply tied to | News Anchor, | | look beyond |
| | | | | the emotions of | Editor, | | the known to |
| | | | | others and | Musician, | | explore the |
| | | | | tends to be | Product | | possibilities |
| | | | | extremely | Manager, | | that lie within |
| | | | | generous and | Elementary | | the unknown. |
| | | | | caring. Though | School | | When in a |
| | | | | at the center of | Teacher, | | deep |
| | | | | everything, The | Personal | | meditative |
| | | | | Spirit freely | Trainer, Social | | state, you |
| | | | | traverses | Worker | | observe and |
| | | | | through | | | share the |
| | | | | conversation | | | emotions, |
| | | | | and social | | | feelings, and |
| | | | | group, | | | thoughts of |
| | | | | captivating and | | | those within |
| | | | | impressing all. | | | reach |
| | | | | They aim to feel | | | including |
| | | | | connected to | | | problems |
| | | | | and inspired by | | | affecting |
| | | | | others and | | | humanity, |
| | | | | ignite | | | causing you |
| | | | | possibilities and | | | to create |
| | | | | ideas within | | | infinite |
| | | | | themselves and | | | possibilities |
| | | | | all they touch. | | | grounded by |
| | | | | The Spirit is | | | philosophy |
| | | | | known to | | | and driven |
| | | | | strongly pursue | | | intuition. |
| | | | | the sense of the | | | Those within |
| | | | | possible and | | | reach |
| | | | | have | | | instantly see |
| | | | | outstanding | | | the world |
| | | | | intuitive power. | | | through your |
| | | | | Through deep | | | philosophical |
| | | | | philosophical | | | lens; |
| | | | | reasoning, they | | | strengthen |
| | | | | deliver | | | their social |
| | | | | incredibly | | | action |
| | | | | profound | | | accuracy |
| | | | | insights on the | | | and impact. |
| | | | | human | | | |
| | | | | condition and | | | |
| | | | | can discuss it | | | |
| | | | | with others in | | | |
| | | | | depth. | | | |
| Ambassador | Diplomats | INFJ | The | As a true | Counselor, | Neutralization | With an |
| | | | Antidote | difference | Writer, | | effortless |
| | | | | maker, Allegiant | Scientist, | | wave of the |
| | | | | dedicates their | Librarian, | | hand, The |
| | | | | life to bring | Psychologist, | | Antidote |
| | | | | happiness to | Consulting | | instantly |
| | | | | others. They | | | shifts the |
| | | | | easily feel | | | perspectives |
| | | | | empathy for all | | | of those in |
| | | | | in pain and stop | | | reach to |
| | | | | at nothing to | | | negate |
| | | | | help in any way | | | conflict, and |
| | | | | possible. | | | create sound |
| | | | | Though they | | | solutions. |
| | | | | have made it | | | |
| | | | | their personal | | | |
| | | | | mission to make | | | |
| | | | | a difference in | | | |
| | | | | the lives of | | | |
| | | | | others, | | | |
| | | | | Allegiants do | | | |
| | | | | not care for the | | | |
| | | | | spotlight and | | | |
| | | | | intensely | | | |
| | | | | focus on | | | |
| | | | | bringing their | | | |
| | | | | impactful ideas | | | |
| | | | | into reality. As | | | |
| | | | | the superhero | | | |
| | | | | that absorbs the | | | |
| | | | | emotion of all | | | |
| | | | | beings, | | | |
| | | | | Allegiants enter | | | |
| | | | | a deep state of | | | |
| | | | | meditation after | | | |
| | | | | intense | | | |
| | | | | situations to | | | |
| | | | | process and | | | |
| | | | | understand the | | | |
| | | | | truth within | | | |
| | | | | every | | | |
| | | | | perspective | | | |
| | | | | encountered. | | | |
| | | | | For those within | | | |
| | | | | reach, | | | |
| | | | | Allegiants | | | |
| | | | | absorb and | | | |
| | | | | instantly | | | |
| | | | | eliminate all | | | |
| | | | | negative | | | |
| | | | | emotions, | | | |
| | | | | causing those | | | |
| | | | | affected to enter | | | |
| | | | | a state of | | | |
| | | | | peaceful bliss. | | | |
| Ambassador | Diplomats | ENFJ | Vision | After entering | Guidance | Matter | The ability to |
| | | | | the world as an | Counselor, | Conversion | manipulate |
| | | | | infant from a | Sales | (Visionary | reality |
| | | | | nearby planet, | Manager, HR | Streak) | through |
| | | | | Vision grew to | director, Art | | intense |
| | | | | love all forms of | Director, Public | | visions |
| | | | | human | Relations | | powered by |
| | | | | interaction and | Manager | | those within |
| | | | | evolution in | | | reach. |
| | | | | both the | | | |
| | | | | practical and | | | |
| | | | | abstract sense. | | | |
| | | | | As persistent | | | |
| | | | | learners and | | | |
| | | | | observers of the | | | |
| | | | | universe around | | | |
| | | | | them, this | | | |
| | | | | superhero | | | |
| | | | | easily | | | |
| | | | | formulates | | | |
| | | | | ideas for great | | | |
| | | | | change; using | | | |
| | | | | their people | | | |
| | | | | skills to connect | | | |
| | | | | communities, | | | |
| | | | | bridge gaps | | | |
| | | | | between | | | |
| | | | | cultures, and | | | |
| | | | | impact the lives | | | |
| | | | | of others. This | | | |
| | | | | superhero has | | | |
| | | | | the unique | | | |
| | | | | ability to deeply | | | |
| | | | | understand | | | |
| | | | | issues and | | | |
| | | | | problems, and | | | |
| | | | | create | | | |
| | | | | groundbreaking | | | |
| | | | | solutions that | | | |
| | | | | shape our | | | |
| | | | | tomorrow. | | | |
| Vanguard | Explorers | ISFP | Astro | As ethereal | Bookkeeper, | Astral Intuition | The ability to |
| | | | | beings, Astro's | Social Media | | absorb |
| | | | | soar above and | Manager, | | information |
| | | | | beyond to make | Optician, | | from their |
| | | | | the biggest | Veterinarian, | | environment |
| | | | | difference in the | Archeologist, | | including the |
| | | | | universe. They | Social Worker, | | energy within |
| | | | | constantly | Occupational | | universal |
| | | | | weigh the worth | Therapist | | patterns. |
| | | | | and importance | | | With this |
| | | | | of every | | | energy, Astro |
| | | | | situation and | | | predicts |
| | | | | action before | | | events prior |
| | | | | making the | | | to their |
| | | | | biggest impact | | | unfolding |
| | | | | possible. These | | | and can |
| | | | | superheros sit | | | provide |
| | | | | in the stars, | | | thoughtful |
| | | | | intensely | | | insights |
| | | | | observing the | | | towards the |
| | | | | world around | | | outcome of |
| | | | | them, and can | | | social action. |
| | | | | easily recognize | | | This is |
| | | | | patterns during | | | extremely |
| | | | | any situation. | | | useful for |
| | | | | Astros' move | | | helping |
| | | | | with | | | fellow |
| | | | | compassion | | | superheros |
| | | | | and care and | | | create and |
| | | | | change the | | | execute |
| | | | | world by calling | | | solutions on |
| | | | | out to each | | | a massive |
| | | | | individual's | | | scale. |
| | | | | motivations and | | | |
| | | | | desires | | | |
| | | | | unmatched | | | |
| | | | | accuracy. | | | |
| Vanguard | Explorers | ESFP | The Spark | Living for the | Event Planner, | Dynamic | The ability to |
| | | | | moment, The | Professional | Combustion | ignite |
| | | | | Spark is a true | Entertainer, | (Radical | enhanced |
| | | | | lover of joy and | Sales | Combustion, | resourcefulness, |
| | | | | happiness. This | Representative, | Resourcefulness | super |
| | | | | superhero | Cosmetologist, | and | intelligence, |
| | | | | believes that | Flight | Intelligence) | and positivity |
| | | | | everyone is a | Attendant, Tour | | within |
| | | | | part of the | Guide | | everyone |
| | | | | bigger | | | they reach; |
| | | | | community and | | | radiating |
| | | | | has an impact | | | warmth and |
| | | | | on the world | | | optimism |
| | | | | around them. | | | throughout |
| | | | | Opportunistic | | | each |
| | | | | and ambitious, | | | community |
| | | | | The Spark | | | they reside. |
| | | | | ignites positivity | | | |
| | | | | within everyone | | | |
| | | | | they touch; | | | |
| | | | | radiating | | | |
| | | | | warmth and | | | |
| | | | | optimism within | | | |
| | | | | each | | | |
| | | | | community they | | | |
| | | | | reside. These | | | |
| | | | | superheros are | | | |
| | | | | masters of | | | |
| | | | | connecting | | | |
| | | | | themselves to | | | |
| | | | | the resources | | | |
| | | | | needed to bring | | | |
| | | | | any plan or idea | | | |
| | | | | to life. | | | |
| Vanguard | Explorers | ISTP | The | Free Spirited, | Technician, | Tunnel Vision | The ability to |
| | | | Technician | Independent, | Construction | | ignore all |
| | | | | Focussed, and | Worker, | | distractions |
| | | | | Analytical, the | Engineer, | | and |
| | | | | Technician | Forensic | | emotions |
| | | | | thrives on logic, | Scientist, | | when dealing |
| | | | | adventure, and | Inspector | | with complex |
| | | | | excitement. | | | issues. |
| | | | | Always moving | | | |
| | | | | and searching | | | |
| | | | | for the next | | | |
| | | | | adventure, this | | | |
| | | | | superhero | | | |
| | | | | values loyalty | | | |
| | | | | and action over | | | |
| | | | | all. The | | | |
| | | | | Technician is | | | |
| | | | | prepared to | | | |
| | | | | lend a helping | | | |
| | | | | hand at any | | | |
| | | | | moment and is | | | |
| | | | | not afraid to | | | |
| | | | | approach new | | | |
| | | | | problems and | | | |
| | | | | interests with | | | |
| | | | | the intent to | | | |
| | | | | make an impact | | | |
| | | | | on a large or | | | |
| | | | | small scale. | | | |
| Vanguard | Explorers | ESTP | The | Naturally | Firefighter, | Chance | The ability |
| | | | Daredevil | independent, | Paramedic, | | to observe |
| | | | | driven, and | Creative | | and create |
| | | | | intelligent, the | Director, | | the tools |
| | | | | Daredevil | Project | | needed to |
| | | | | transforms | Coordinator, | | give all in |
| | | | | emotions into | Construction | | reach the |
| | | | | ideas, and | Manager | | increased |
| | | | | brings ideas | | | likelihood |
| | | | | into our reality. | | | of success. |
| | | | | Though | | | |
| | | | | independent, | | | |
| | | | | these | | | |
| | | | | superheros are | | | |
| | | | | extremely | | | |
| | | | | passionate | | | |
| | | | | about arming | | | |
| | | | | others with the | | | |
| | | | | tools needed to | | | |
| | | | | improve lives | | | |
| | | | | for the better. | | | |
| | | | | Daredevils | | | |
| | | | | naturally | | | |
| | | | | observe, | | | |
| | | | | understand and | | | |
| | | | | instantaneously | | | |
| | | | | apply their | | | |
| | | | | creative thinking | | | |
| | | | | abilities in all | | | |
| | | | | aspects of | | | |
| | | | | existence. | | | |

### Zodiac Usage

Zodiac information will be utilized to independently frame and personalize each account experience. Additionally, Phaction uses zodiac information to refine engagement strategies and direct specific content towards users based on the highest likelihood of engagement.

### The DAC Point and Reward Program

In addition to the point and level system discussed above, Phaction provides members with points for each DAC they complete. Based on the number of beneficiaries a DAC impacts and the type of action taken by the member, Phaction may provision points to the respective account. Accounts may use these points to donate to other philanthropic entities and DACs on the Phaction App. Phaction will expand this program to include external rewards for Phaction members via partnerships with corporations including, but not limited to: airline, video games, media, clothing, and lifestyle product companies. The schema is as follows

### DAC Completion & Associated Points

Once each member increases their level associated with their philanthropic role, they can receive a set number of points dictated by Phaction staff upon further development and case studies. As each level increases, the number of points awarded to members also increases. The rewards system associated with collected points will be decided upon further development. As stated above, Phaction members will be able to redeem points in the form of Phaction Dollars that can be used for DAC engagements, or external rewards and programs offered by Phaction Partners, affiliated organizations and other associated entities.

### Social Action Badges and Awards

Phaction provides independent awards or badges for users with outstanding platform activity and philanthropic or social action taken through the Phaction App. Each provisioned badge or award will be accompanied with a physical or virtual prize to be used either within or outside of Phaction. The prizes will be separate from the ones discussed above. The goal of this badge & prize is to incentivize users with outstanding activity to continue to engage in philanthropy at higher rates.

### 5) Insights & Analytics

Phaction provides a variety of insights within analytical dashboards for members to understand and maximize their influence, philanthropic presence, and social impact. The initial insights offered by Phaction will be compiled into a single dashboard or separated into multiple dashboards located in the accounts philanthropic control center. In addition, Phaction Content Items and Pheels will contain minute analytics for account understanding of real-time engagement. All analytical information will be generated and calculated at the time of request and specific user analytical information is not publicly stored or viewable by other accounts. Phaction will offer insights within the following categories: Accounts & Phaction Pages Activity, Audience Activity, Deck Activity, Phaction Content Items Insights, Pheel Activity, Philopics, and Philanthropy & DAC Insights. All insights within each category will be tiered by account verification status for consumer consumption based on computational power and other factors discovered during development. Depending on account verification status, specific insights will also be provided for individual purchase or subscription. Phaction also reserves the right to offer insights to consumers following additional communication with the involved parties. Information related to insights such as time range constraints for retrieving and storing insights, endpoints for external access and insight exports, and insight strategies for advertisements and endpoint usage will be constructed and mitigated upon further development.

### Account & Phaction Page Analytics

Phaction provides all members with a dashboard to analyze their account, account profile, Philanthropic Organizer, and associated Phaction Page Activity. Information displayed on this dashboard includes, but is not limited to:

Impressions: number of times that the account's profile or Phaction Content Items have been viewed. This includes views and activity generated through API's, Ads, comments, shares, searches, and other promotional capabilities and features.

Industry Standard Impressions: The percentage of impressions abiding by the MRC standard (50% of pixels in-view for at least 2 continuous seconds).

Reach: number of unique accounts that have seen the accounts profile or at least one of the accounts Phaction Content Items. All repeat views are counted as one view. This includes views and activity generated through API's, Ads, comments, shares, searches, and other promotional capabilities and features.

Engagement: total number of interactions a Phaction Account and Phaction Content Items displayed on the account profile receives. This includes the total number of followers acquired, comments, shares, gestures, saves, clicks and philanthropic actions taken on Phaction Account or on Phaction Content Items located on Phaction Account. This will be organized independently, by engagement type, and in aggregate for members to view over a period of time.

Engagement Rate: engagement divided by impressions.

Profile Views: the number of times an account profile is viewed by people both logged into Phaction and not. This metric is displayed by day over a specific period of time.

Philanthropic Organizer Visits: Number of times an accounts philanthropic organizer is viewed by a Phaction member. This only counts if the philanthropic organizer loads.

Pheel Visits: The number of times a pheel is viewed from the account profile.

My Pheed Visits: The number of times a “My Pheed” pheed has been viewed. This only counts if an individual scrolls to view the content within the pheed.

My Phlix Visits: The number of times a “My Phlix” pheed has been viewed. This only counts if an individual scrolls to view the content within the pheed.

My Phruit Visits: The number of times a “My Phruit” pheed has been viewed. This only counts if an individual scrolls to view the content within the pheed.

Philanthropic Impression: total number of times a DAC, DAC Page, philanthropic prestige account content item, or a philanthropic prestige account profile was viewed from your Phaction Account and Phaction Content Items.

Philanthropic Reach: total number of unique accounts that viewed a DAC, DAC Page, philanthropic prestige account content item, or a philanthropic prestige account profile from your Phaction Account and Phaction Content Items.

Account DAC Conversion Rate: total number of unique accounts that completed a DAC, or followed a DAC page or philanthropic prestige account, promoted on the account profile or located in the philanthropic organizer divided by the total amount of times the DAC or philanthropic content item was viewed on the account profile or philanthropic organizer. This is only counted if a Phaction member views the promoted DAC; scrolls are not counted.

Account Conversation Spark Rate: total number of comments and replies per post for a Phaction Account divided by the total engagement.

Account Whispers: the total number of mentions and philopics referencing Phaction account. This will be displayed by day over a specific time period.

Click Total: total number of clicks or taps on Phaction Content Items shown on the account profile.

Click-through rate: The number of clicks to Phaction Content Items on the Account Profile divided by impressions.

Average View Time: The average amount of time a Phaction Member spends viewing Phaction Account.

### Audience Insights

Within the Account and Phaction Page Dashboard, Phaction Members can view specific insights on their audience demographics, interests, and activity. The audience insights below will vary depending on account verification status and purchased insights:

Audience City: The cities of Phaction Account's friends. This includes champions for verified accounts.

Audience Country: The countries of Phaction Account's friends. This includes champions for verified accounts.

Audience Zip Code: The zip code of Phaction Account's friends. This includes champions for verified accounts.

Audience Gender: The gender of Phaction Account's friends. This includes champions for verified accounts.

Audience Age: The age of Phaction Account's friends. This includes champions for verified accounts.

Audience Occupation: The occupation of Phaction Account's friends. This includes champions for verified accounts.

Audience Race & Ethnicity: The race and ethnicity of Phaction Account's friends. This includes champions for verified accounts.

Audience Locales by Country Code: The locales country code of Phaction Account's friends. This includes champions for verified accounts.

Audience Interest: The Top 10 philopics engaged with by Phaction Account's friends and champions.

Audience Personality Distribution: distribution of friends and champions based on personalities.

Visitor Demographics: The demographics of the people viewing your page but not an account friend or champion. This includes occupation, location, age, gender, ethnicity, and race.

Email Contacts: Total number of taps to the email link in Phaction Account Profile.

Call Contacts: Total number of taps to the call link in Phaction Account Profile.

Text Contacts: Total number of taps to the text link in Phaction Account Profile.

Social Media Contacts: Total number of taps to social media links in Phaction Account Profile.

Follower Count—Total number of new followers each day within a specified day.

New Follower Rate: number of followers per day divided by the total amount of followers obtained over a specified period

Active Members: Total amount of friends or champions who were active or online during the specified period.

Active to Inactive Member Rate: Total number of friends or champions who were active or online divided by the total number of friends or champions who were inactive active or offline during the specified period.

Website Clicks: total number of times your website link was clicked in the account profile.

Location Clicks: total number of times a location link was clicked in the account profile.

Follower Growth: the difference between the amount of followers gained and the amount of followers lost over a specific time period.

Follower Growth Rate: the total amount of followers gained divided by the total amount of followers lost over a specific time period.

### Deck Insights

Phaction Decks allow members to display multiple posts or DACs in a single pheed item. These insights will be available for all members regardless of account verification status. For Decks, Phaction provides the following insights:

Deck Engagement: total number of interactions a Phaction Deck Content Item obtains. These include the total number of comments, shares, gestures, and saves taken on the Deck. This will be organized independently, by type, and in aggregate for members to view over a period of time.

Deck Impressions: total number of times Phaction Deck Content Item has been seen.

Deck Engagement Rate: Deck Engagement divided by Deck Impressions.

Deck Reach: total number of unique accounts that have seen Phaction Deck Content Item.

Deck Saves: total number of unique accounts that saved a Phaction Content Item.

### Pheel Insights

With Pheels, all members can upload and promote live or prerecorded videos to share and showcase philanthropic and social issue involvement. Pheel insights allow Phaction members to understand how their videos are being engaged with and interpreted. The below insights are available for all members regardless of account verification status.

Pheel Engagement: total number of interactions a Phaction Pheel Content Item obtains. These include the total number of comments, shares, gestures, saves and philanthropic actions taken on the Pheel. This will be organized independently, by type, and in aggregate for members to view over a period of time.

Close Count: Number of times someone closes a pheel before the end.

Average Play Time: the average amount of time a pheel is played before being closed.

Pheel Impressions: Total amount of times the Pheel content item has been seen.

Pheel Engagement Rate: Pheel Engagement divided by Pheel Impressions.

Reach: Total number of unique Phaction members that have seen the pheel content item.

Share Count: Total amount of time the pheel has been shared during a 24 hour time period.

Reply Count: Total amount of replies the pheel receives over a 24 hour time period.

Gesture Total: Total amount of gestures the pheel receives over a 24 hour time period.

Gesture Count by Type: Total amount of gestures by type that the pheel receives over a 24 hour time period.

Pro Tap Count: Total number of taps to see the pheels next content item.

Pre Tap Count: Total number of taps to see the pheels previous content item.

Philopic Click Count: Total number of taps to specific philopics for pheels containing philopics,

Top Pheels: The pheels that generated the most reach and engagement.

### Phaction Board Insights

Whenever individuals include Phaction Boards on their websites or apps, they can view the below metrics within their analytics dashboard. This will only be available for developer accounts:

Phaction Board Impressions: Total number of people that have seen Phaction Board.

Phaction Board Reach: Total number of unique individuals that have seen Phaction Board.

Phaction Board Engagement: Total number of people that have clicked on Phaction Board.

Phaction Board Engagement Rate: Phaction Board Engagement divided by Phaction Board Impressions.

Phaction Board Conversion: The number of times a Phaction Member takes action after clicking on the board.

Phaction Board Followers: total number of new followers gained from Phaction Board. This is shown by day over a specific time period.

### Phaction Content Item Insights

Phaction provides all members with a dashboard for analyzing activity generated from all content created by, promoted, produced by, or shared through Phaction account. Phaction Content Items include, but are not limited to: posts, pheeds, phlix, and phruits. This dashboard will be tailored based on account verification status and purchased upgrades. Information displayed on this dashboard includes, but is not limited to:

Content Engagement: total number of interactions a Phaction Content Item obtains. These include the total number of reposts, comments, shares, gestures, saves, clicks, and philanthropic actions taken on Phaction Content Item. This will be organized independently, by type, and in aggregate for members to view over a period of time.

Content Impressions: total number of times Phaction Content Item has been seen.

Content Engagement Rate: total engagement divided by total impressions.

Content Reach: total number of unique accounts that have seen Phaction Content Item.

Saved Count: total number of unique accounts that saved a Phaction Content Item.

Video Views: Total number of times a video has been seen.

Video Play Time: The average amount of time a video is played for before being closed.

Image Views: Total number of times an image has been seen.

Phlix View: total number of times a Phlix has been seen.

Conversions: The number of times a Phaction Member takes action after clicking on or viewing Phaction Content Item.

Conversion Rate: Conversion divided by impressions.

Philopic Impression: total number of interactions a philopic created by or referencing a Phaction Member or Account receives.

Philopic Reach: total number of unique interactions a philopic created by or referencing Phaction Member or Account receives.

Philopic Click Count: Total number of taps to specific philopics for Phaction Content Items containing philopics. This will be shown in aggregate and by philopic.

Profile Clicks: total number of times your profile was clicked from a specific Phaction Content Item.

Paid Reach: The number of unique people that viewed or saw a paid post or content item.

Organic Reach: The number of unique people that viewed or saw an unpaid post or content item.

Link/URL Clicks: total number of times a link or URL was clicked in Phaction Content Item.

Top Philopics: The philopics generated by the account that produced the most impressions, reach, and engagement.

Top Posts: The posts generated by the account that produced the most impressions, reach, and engagement.

Top DACs: The DACs generated, reposted, and engaged with by the account that produced the most impressions, reach, and engagement.

Top Phruits: The phruits generated or reposted by the account that produced the most impressions, reach, and engagement.

Gesture Total: Total amount of gestures Phaction Content Item receives over a 24 hour time period.

Gesture Count by Type: Total amount of gestures by type that Phaction Content Item receives over a 24 hour time period.

Average View Time: The average amount of time a Phaction Member views a Phaction Content Item for.

Click-through rate: The number of clicks to links within Phaction Content Items divided by impressions.

Click Total: total number of clicks or taps on Phaction Content Item.

### Philanthropic & DAC Analytics

These insights are privy to only nonprofits with philanthropic prestige accounts and select data partners.

Donor, Beneficiary, Volunteer, and Participant Audience Locale Code: The locales country code of Phaction Philanthropic Prestige Account's Audience by Audience Type (Donor, Beneficiary, Volunteer, Participant).

Donor, Beneficiary, Volunteer, and Participant Audience City: The city distribution of Phaction Philanthropic Prestige Account's Audience by Audience Type (Donor, Beneficiary, Volunteer, Participant).

Donor, Beneficiary, Volunteer, and Participant Audience Country: The country distribution of Phaction Philanthropic Prestige Account's Audience by Audience Type (Donor, Beneficiary, Volunteer, Participant).

Donor, Beneficiary, Volunteer, and Participant Audience Age: The age distribution of Phaction Philanthropic Prestige Account's Audience by Audience Type (Donor, Beneficiary, Volunteer, Participant).

Donor, Beneficiary, Volunteer, and Participant Audience Gender: The gender distribution of Phaction Philanthropic Prestige Account's Audience by Audience Type (Donor, Beneficiary, Volunteer, Participant).

Donor, Beneficiary, Volunteer, and Participant Audience Race & Ethnicity: The race & ethnicity distribution of Phaction Philanthropic Prestige Account's Audience by Audience Type (Donor, Beneficiary, Volunteer, Participant).

Donor, Beneficiary, Volunteer, and Participant Audience Occupation: The occupation of Phaction Philanthropic Prestige Account's Audience by Audience Type (Donor, Beneficiary, Volunteer, Participant).

Donor, Beneficiary, Volunteer, and Participant Audience Social Media Distribution: The total number of members with connected social media accounts per entity (Twitter, Facebook, Instagram, LinkedIn) divided by the total number of friends and champions.

DAC Impression: total number of times a DAC was viewed from Phaction Account profile, DAC Page or Phaction Content Item

DAC Reach: total number of unique accounts that viewed a DAC from the Clarintel Account profile, DAC Page, or Phaction Content Item.

DAC Fulfillment: the total number of times a DAC is fulfilled.

DAC Engagement: the total number of comments, gestures, champions, shares, philopic references, fulfillments, actions, and mentions a DAC obtains.

DAC Engagement Rate: DAC Engagement divided by DAC Impressions.

DAC Page Views: The amount of times the DAC page was visited or viewed. This does not include DAC Page previews.

Philanthropic Reach: total number of unique accounts that viewed a DAC, DAC Page, or philanthropic prestige account from your Phaction Content Item.

DAC Conversion: total number of times an action has been taken on a DAC that was viewed or clicked from your account profile or Phaction Content Item.

DAC Conversion Rate: DAC Conversions divided by DAC Impressions.

Nonprofit Website Visits: number of times the nonprofits website was visited from the DAC or DAC page.

Time Before DAC Conversion: The amount of time between when a specific Phaction Member views the DAC, DAC Page promotion, or DAC Page and completion of the viewed DAC. This will be shown by each event and averaged.

Donors: the total number of people that have donated to Phaction Philanthropic Prestige Account or a DAC offered by the account.

Recurring Donors: the total number of individuals that have donated to more than one of Phaction Accounts DACs or to the specific account. This user is only counted once for each DAC. The first DAC that they engage with does not count for this insight.

New Donors: total number of new donors a Phaction Accounts DAC receives over a period of time. This is only counted once for each DAC and only if a Phaction Member has never engaged in a DAC promoted by the Philanthropic Prestige Account.

DAC Donors: the total number of donors a Phaction Account receives for a specific DAC.

Donor Retention Rate: The total number of recurring donors divided by the total amount of donors received for a specific DAC. This will also be calculated in aggregate.

Donation Revenue: Total amount of donations received over a period of time. This includes entity specific donations and DACs.

Average Donation: The average amount of all donations accumulated during a specific period of time.

Time Between Action: The average amount of time that passes between an individual account engagement with a DAC and the next account engagement with the same DAC. DAC actions include, but are not limited to donations, petition signings, pledge commitments, volunteer sign ups and petitions sign ups.

Time Before Fulfillment: The amount of time it takes for the DAC to reach its goal since its inception. This is measured from the start of the DAC, when the DAC becomes active, until the DAC is completed and considered inactive.

Signers: the total number of people that fulfilled a Petition DAC offered by Phaction Philanthropic Prestige Account.

Recurring Signers: the total number of people that have signed 2 or more Petition DACs offered by Phaction Philanthropic Prestige Account.

New Signers: total number of new signers a Phaction Accounts DAC receives over a period of time. This is only counted once for each DAC and only if a Phaction Member has never engaged in a DAC promoted by the Philanthropic Prestige Account.

Signer Retention Rate: total number of recurring signers divided by the total number of signers per DAC. This will also be calculated in aggregate.

Pledge Views: the total number of times a philanthropic prestige accounts pledge was viewed.

Pledge Commitments: The number of unique accounts that signed the pledge.

Pledge Commitment Rate: The total pledge commitments divided by the total number of pledge views.

Volunteer Sign Up: The total number of people that signed up to volunteer for DAC offered by Phaction Philanthropic Prestige Account.

Volunteer Fulfillments: The total number of people that fulfilled a volunteer opportunity discovered in a DAC offered by Phaction Philanthropic Prestige Account and proved fulfillment via a Phaction Content Item.

Recurring Volunteers: The total number of people that fulfilled 2 or more volunteer opportunities discovered in DACs offered by Phaction Philanthropic Prestige Account and proved fulfillment via a Phaction Content Item.

New Volunteers: The total number of new people that fulfilled a volunteer opportunity discovered in a DAC offered by Phaction Philanthropic Prestige Account and proved fulfillment via a Phaction Content Item. This is only counted once for each DAC and only if a Phaction Member has never engaged in a DAC promoted by the Philanthropic Prestige Account.

Volunteer Fulfillment Rate: Volunteer Fulfillments divided by Volunteer Sign Ups.

Volunteer Retention Rate: Recurring Volunteers divided by Volunteer Fulfillments.

Participants & Attendee Sign Up: the total number of people that signed up to participate in or attend a DAC offered by Phaction Philanthropic Prestige Account.

Participants & Attendee Fulfillments: The total number of people that participated or attended the event discovered in a DAC offered by Phaction Philanthropic Prestige Account and proved fulfillment via a Phaction Content Item.

Recurring Participants & Attendees: the total number of people that participated or attended 2 or more events discovered in DACs offered by Phaction Philanthropic Prestige Account and proved fulfillment via a Phaction Content Item.

New Participants & Attendees: the total number of new people that participated or attended an event discovered in a DAC offered by Phaction Philanthropic Prestige Account and proved fulfillment via a Phaction Content Item. This is only counted once for each DAC and only if a Phaction Member has never engaged in a DAC promoted by the Philanthropic Prestige Account.

Participant and Attendee Fulfillment Rate: Participant and Attendee Fulfillments divided by Participant and Attendee Sign Ups.

Participant and Attendee Retention Rate: Recurring Participants & Attendees divided by Participant and Attendee Fulfillments.

DAC Accomplishment Rate: The amount of DAC's that reach their goal divided by the total amount of DACs promoted on the Phaction App.

DAC Beneficiaries: Total number of beneficiaries from active DACs at any given time. This can also be segmented by DAC.

Beneficiary Follow Up Response Rate: After each completed DAC, a follow up survey will be automatically sent to each respective account that engages with the DAC. The total amount of DAC follow-up surveys completed divided by the total amount of follow up surveys sent.

Beneficiary Satisfaction Rate: The Beneficiary Satisfaction Rate is measured by dividing the positive follow up survey responses by the total amount of recorded follow up responses.

Beneficiary Dissatisfaction Rate: Similar to above, the Beneficiary Dissatisfaction Rate is measured by dividing the negative follow up responses by the total amount of recorded follow up responses.

Total Lives Reached: The total number of unique beneficiaries reached, assisted, or impacted. This will be shown in aggregate and by DAC.

Recurring Analysts: The total amount of people that engage with analytical content, including data visualizations and Phruits, on two or more occasions.

New Analysts: Total number of new people that engage with analytical content offered by a Phaction Account over a period of time. This is only counted once for each content item and only if a Phaction Member has never engaged in the accounts analytical content item.

Philanthropic Conversation Rate: Comments, Shares, and Replies to DAC Posts, Pages, and DAC Content divided by total DAC engagement.

### Similarity Scores

All Phaction Members will have the ability to compare Phaction Accounts based on their philanthropic and social activity, interests, and other factors that will be determined during development. Each comparison will be calculated independently from each other and the average of each calculation will be taken to produce the similarity score. The similarity score allows members to compare all Phaction Accounts given a variety of factors focussed on what members care about. Each formula will be customizable by all members and additional categories will be created in the future given member feedback and recommendations. In the future, similarity scores will be expanded to include nonprofit specific comparisons. Similarity scores will be automated and viewable for each member independently by visiting the account of interests profile. Each category used to comprise the similarity score is independently discussed below:

Interests: All content on Phaction is categorized using philopics. For two Phaction members, similarities in interest will be measured by comparing philopics followed, favorited, engaged, and frequently visited by each respective member. Philopics directly matching in activity will receive a score of 1, symbolizing a match. For remaining philopics, semantic and synset algorithms will be applied using Natural Language Processing AI models to compare philopics that may be indirectly related. The aforementioned algorithms will return a number between 0 and 1 dictating the distance in similarity between each philopic. Each value returned will be summated and divided by the total number of philopics compared and matched. In addition, Phaction will include the total amount of philopics not matched to reduce algorithmic bias. This algorithm will be run independently for philanthropic and general philopics of interest.

Activity: Similarity in Activity will be determined using engagement and impressions. Phaction will directly compare content engaged with and viewed including the specific type of engagement enacted by each member being compared. In addition, Phaction will take into account the frequency of engagement, content conversion time, content types including topics and form, gesture usage, and philopic usage. Finally, a semantic analysis will be applied to members' public responses and posts for identification of similar emotional responses to content and events.

Network: To identify similarities in networks, Phaction compares mutual friends and champions shared between members. This includes all verified accounts. Friends and champions directly shared between members may receive a score of 1. Friends of friends, champions of champions, or accounts shared by members within one person or intermediary, receive a score of 0.5. Likewise, friends of friends of friends, or shared accounts within a two people reach, receive a score of 0.25. Accounts within a reach of three people receive a score of 0.1. Similar to above, each value will be summated and divided by the total number of values used for the calculation.

Public Personal Information: For this category, all personal information fields that directly match receive a 1. Likewise, no match receives a 0. The values used for this score include, but are not limited to the members personality type, hometown, current location, specific locations of interest, zodiac sign, occupation, age, and all other publicly released personal information outside of philanthropic interests. This similarity score is represented by taking the average of the summated values.

Philanthropic Interests: This category will contain a variety of methods used in the aforementioned calculations. The fields used to determine philanthropic similarity include, but are not limited to: philanthropic roles and associated levels, philanthropic badges, DACs of interest, DAC impressions and engagements, and followed philanthropic prestige accounts.

Nonprofit Specific Comparisons: Based on information collected by Phaction, historical IRS data, and Phaction activity, Phaction members will be able to compare two or more nonprofit or philanthropic entities based on historical and current philanthropic, financial, and social data. This approach will be expanded upon further development, data aggregation, and analysis regarding the social sector.

### Feedback Loop Health

An account's feedback loop consists of gestures, comments, shares, and replies to Phaction Content Items generated, produced, or promoted by the original account. In addition to insights collected through gestures and shares, Phaction utilizes a Natural Language Processing AI Model to perform a sentiment analysis on comments and content replies attached to the accounts Phaction Content Items to detect positive and negative emotions generated from account content. Depending on the average emotional response given the aforementioned approaches including gesture and share insights, Phaction administers a score representing the health of the accounts Feedback Loop. For Philanthropic prestige accounts, DAC follow up responses and comments will be included in this calculation.

### Related Philogics

Phaction will utilize a Natural Language Processing AI Model to auto-generate philopics related to those most commonly used by the social sector. In addition, Phaction Members can use this feature to explore content aligning with known interests and to expand the audience reach of philanthropic, social issues, and other strategic approaches taken by individuals, organizations, and entities based on aligning interest.

### The Future of Insights

Upon further research, Phaction plans to release the following analytics for public use:

Philanthropic Conversation Health: This is a measurement for determining the emotional health of your posts and post replies.

Philanthropic Influence: Philanthropic influence represents the amount of Phaction members, both connected and not connected to the account of interest, that the account can influence to engage in philanthropic content.

Social Impact: A member-specific measurement that quantifies the amount of impact a Phaction Members philanthropic activity has accrued. This measure is platform specific and is analyzed using DACs curated by verified philanthropic entities.

Social Influence: Similar to Philanthropic influence, social influence represents the amount of Phaction members, both connected and not connected to the account of interest, that the account can influence to engage in any type of content. This measure excludes philanthropic influence.

Social Capital: Social capital represents the likelihood that a member can influence a portion of Phaction's “society” or population to do anything at any time. This measure will be calculated by taking the average of a member's social influence, philanthropic influence, social impact, engagement, impressions, and reach.

### 6) Data Collection and Analysis

Phaction believes that the key to advancing social action and philanthropy lies within a deep understanding of social issues, the entities fighting social issues, and the individuals assisting entities to change the world in any way possible. In alliance with our mission to promote and redefine social action and philanthropy, Phaction consistently performs vetting of all social sector entities, surveys the researched entities, performs detailed analysis using data algorithms and artificial intelligence models, and provides data focused feedback on social sector strategies, approaches, impact, and public perceptions. In addition, Phaction executes a variety of ad hoc analytical strategies to both deepen and broaden internal and stakeholder understanding of social issues and societal impact.

### Social Sector Vetting

Phaction provides a deeper level of understanding and heightened intelligence regarding social issues, philanthropy, and social sector entities. Phactions's patent pending process for vetting social sector entities is broken into two steps: discovery and data mining; both based on public facing information.

### Social Sector Vetting: Discovery

Phaction will begin by sourcing nonprofits that are focused on racial equity, and improving life for African Americans. After identifying a nonprofit or philanthropic entity, Phaction collects the following information:

Mission, Value, Social Issue, and Target Audience alignment with Phaction: Entities must align with Phaction's mission, goals, focus areas, and social impact objectives.

IRS Recognition, Nonprofit Status, EIN, and Proof of Determination: Each nonprofit organization partnered with Phaction must have 501 (c3) status at the time of partnership or account provisioning.

Proof of Donation Reception & Connection to Legitimate US Banking Institutions: All nonprofits selected must be connected to legitimate US financial institutions in order to receive monetary donations. This dramatically reduces the rate of fraudulent and suspicious behaviour including scams and misinformation.

Fundraising ROI: This KPI is an evaluation of the total number of funds coming in per dollars spent on fundraising. To calculate this, we divide the total costs by the total funds raised. The lower the cost, the better.

Total Number of Beneficiaries Served: The total number of targeted beneficiaries served by an organization through programs, activities, or events over a specific period of time.

Total Program Attendance: The total number of targeted beneficiaries and individuals that attend any given program that a nonprofit organizes with the intention of furthering their missions.

Year Over Year Growth: Year-over-year growth is the percentage of revenue, beneficiaries, or budget increases over one year in comparison to the previous year.

Operating Surplus/Deficit: This is a comparison of the expendable net assets to total expenses. The goal is to have an operating reserve to cover at least 3 months of annual expenses.

Liquid Unrestricted Net Assets: This refers to a portion of a nonprofits' unrestricted net assets that can be converted to cash relatively easily. It also refers to the funds available for purposes such as supplying working capital, guarding against downturns, and pursuing new opportunities.

Program Efficiency: This identifies the efficiency in nonprofit mission fulfillment by dividing program expenses by total expenses. This also demonstrates how much money is spent on the mission in comparison to administrative costs.

Administrative Yield: This is calculated by dividing the administrative expenses by the total expenses. If this calculation is greater than program efficiency, then the nonprofit is automatically flagged.

Contributions/Donations: This measures the total amount of donations per fiscal period.

Expenses: This measures the amount of money spent per fiscal period.

Revenue: This measures the amount of money obtained per fiscal period.

### Social Sector Vetting: Data Mining

Depending on the result of the previous analysis, Phaction will extend a partnership opportunity to the researched entity or provision a philanthropic prestige Phaction app account. Regardless of whether or not an entity embarks in the aforementioned opportunities, Phaction collects and maintains a record of the information below:

Nonprofit Logistics: Logical information includes the nonprofits name and alias, founders, current executive and management teams, founding date and address, headquarters, active locations and social media handles.

Nonprofit Impact: This category is used to align nonprofits to specific social causes and issues. The information used to determine a nonprofits desired impact includes:

Impact Areas: Impact Areas are defined as the primary social issue category framing a structure, a set of practices, or social issue-based phenomenon either continuously leading to states of marginalization, oppression, anguish, and misery, or attributing to any violation of human rights within specific communities over a period of time. For Example, systems used to oppress include Systemic Racism or Institutionalized Racism. Impact Areas associated with these systems include Health Equity, Policing & Prison Reform, Fair Housing, and Voting Equity.

Impact Subtiers: Impact Subtiers are defined as a subcategory of the primary social issue category directly contributing to the overarching inequity, prejudice, system, social issue-based phenomenon, or set of practices that increases marginalization and oppression towards a subset of a population. This will be used to organize information under specific areas of interest within impact areas.

Subtier Factors: A Subtier factor is defined as a specific disparity, component, or factor directly or indirectly contributing to a specific impact subtier. These factors will be summarized into categories spotlighting issues within the above subtiers. As an example: for the impact area, health equity; a possible impact subtier is pre-existing conditions. Subtier factors for pre-existing conditions include, but are not limited to: health insurance coverage, access to specialized care, medicine or medical resource distribution, and research funding.

Theory of Change: A Theory of Change is a comprehensive description and illustration of how and why a desired change is expected to happen in a particular context. All social sector entities are required to provide a theory of change for the establishment of continuous data reporting for change progression and monitoring. In addition, each theory of change must align with each entity's objective to determine eligibility for partnership and app account provisioning. Key components of the theory of change include:

A. The Goal: This includes the objectives of the philanthropic offering, how success is measured, identification of the intended outcome.

B. Beneficiaries: Those benefiting from the philanthropic opportunity. This includes the target population and characteristics. These characteristics can include demographics, geolocation, occupation, and education level.

C. Change Quantification: This focuses on identifying and quantifying the expected impact of the philanthropic offering. This segment concentrates on the scale of the offering including how many individuals are expected to be impacted and to what degree.

D. Contribution Metrics: This aspect identifies the specific contribution needed by the entities involved to create change relative to what the systems and institutions in place would have completed given natural occurrences.

E. Risk Analysis: This component is utilized to identify the risks associated with the project including internal & external execution, drop off risk, and contribution risk.

F. Expected Outcomes: This component identifies what short term and long term impacts are expected to come from their theory of change.

G. Change Execution & Analysis: The final component identifies how a philanthropic offering will be executed. In addition, all entities must provide measures for tracking the immediate, short term, and long-term impact of the philanthropic opportunities enacted under their theory of change.

Social Sector Entity Audiences: Phaction collects and analyzes nonprofit audience demographics and societal information including, but not limited to: age, occupation, industry, education, residency, socioeconomic standing, class, societal trends, associated belief systems, and personality types. The information used for audience understanding will only be collected from credible sources approved by Phaction's executives and board of directors. Nonprofit audiences will be analyzed and segmented based on beneficiaries, monetary and non-monetary donors, volunteers such as staff and organizers, participants and attendees, and online supporters.

Nonprofit Philanthropic Offerings: Phaction requires all nonprofits to have at least one active philanthropic offering at all times. For all philanthropic offerings, Phaction collects the name of the philanthropic offering, type of philanthropic offering (programs, donations, petitions, pledges, events, initiatives/campaigns, virtual event, in-person events, etc.), the start and end date, the funding, volunteer, participant, and beneficiary goals, the goal of the philanthropic offering, the target audience, and any additional details including a copy of the project plan.

Follow the Money: Follow the money is a deep financial analysis of nonprofit funders and beneficiaries using IRS information and public sources. Phaction will analyze the flow of money between individuals, corporations, and entities to nonprofit organizations including aligning interests, backgrounds, and goals. This analysis will be used to determine the legitimacy of each organization and outcome of each donation.

### Ad-Hoc Approaches

Phaction will perform the below data collection and analysis approaches given social conditions, social issue occurrences, philanthropic opportunities and ventures, direction from the Board of Directors, and other factors to be determined upon further development and research.

Network Partner and Social Sector Surveying: For Phaction, surveys perform two purposes: to validate all publicly sourced information and to deepen our understanding of the social sector, philanthropic goals, and social issue impact. Survey questions will be created based on the information found within the Nonprofit Logistics, Nonprofit Social Media Presence, Nonprofit Impact, Nonprofit Audience, and Nonprofit Philanthropic Offering categories. Following survey creation, the survey will be reviewed by the board and industry professionals before widespread distribution to nonprofit entities. The categories used to create survey questions include, but are not limited to: Nonprofit organizational structure & operational procedures, impact, program & initiative goals, milestones, objectives, and success measures, national, local, and community level social issue focus areas, Projected & expected impacts for national, local, and community level programs & initiatives, Projected estimation of time between philanthropic offering execution and measurable social change, Nonprofit goals regarding participation, volunteers, and funding, Nonprofit difficulties based on social and news media growth & exposure, organization structure and management, time and employee management, internal tracking, data organization and management, talent retention & staffing, operations including day-to-day activities, production, and service provisions, social issue response times, fundraising, fiscal recording & reporting, finance, funding and budgeting, program planning and development, audience attention, retention, and engagement, short & long-term sustainability, collaboration with corporations & nonprofits, public expectation and perception handling, and more as dictated by nonprofit partners or discovered through development, research, or partnerships, Collaborative ventures with nonprofits based on mission, goals, focus and impact areas, audience, interest, and scope alignment, and Collaborative ventures with businesses and corporations based on nonprofit interest and alignment with business mission, goals, values, consumer and audience impact, scope, and sustainability.

Social Issue and Event Triggered Analysis: Phaction personnel aggregate and analyze all social issue information directly and indirectly related to partner nonprofits including information relative to impact area, impact subtier, subtier factors, target locations and populations, mission, and goals. Research personnel will collect social issue information manually and via automated processes using APIs, scripts, database access, or other technological means discovered during development. In addition, social issue and philanthropic data will be collected via paid subscriptions, partnerships, and internal research endeavours as decided by the Board of Directors. Based on the causes and social issues that nonprofits stand for, the principles that nonprofits aligns with, the impact that individual nonprofits aims to achieve, and other factor to be discovered upon the conclusion of the research process including, but not limited to: nonprofit missions, offerings, values, and goals, Phaction will collect, analyze, and generate reports on social issues, social impact, social sector trends, community progression, and specific entities working to build a world based on human equity. Phaction will also analyze social issues and movements given social issue occurrences and the direction of the Board of Directors. Both historical and real-time social issue, social sector, and philanthropic related information will be collected and analyzed using automated and manual approaches including, but not limited to:

A. News Media & Scholarly Article Appearances and Media References: This source will be used for analyzing historical nonprofit offerings, narratives, involvements, social issues, research topics, and social impact as reported in the media.

B. Blog Mentions, References, and Activity: This information will be used to solely determine public perception of nonprofit entities. Phaction will utilize APIs and other technological means to collect relevant content based on specific requirements. The gathered information will be analyzed using ML and AI strategies to generate detailed insights on audiences, ideological influence, narratives, semantics, perceptions, and other factors that will be determined upon further development.

C. Social Media Content Analysis: This source will be used to determine public perception of nonprofit entities and responses to social issues. This information is key for understanding ideological shifts, emotions, and the indirect effects of philanthropy on individual trust, behavior, and actions. We will begin this approach by analyzing keywords & topics presented in applied research approaches and as decided by the Board of Directors.

D. Government Generated Datasets: Phaction will collect all data released by the United States government that is directly or indirectly connected to philanthropy, nonprofits, social issues, and individual communities and institutions impacted by racial equity.

Direct Partner Support: Phaction will also utilize independent partnerships and external means for the creation, reciprocation, and utilization of any materials deemed useful for research or analytical purposes in alignment with Phaction's mission, goals, and objectives. The Partnerships formed for research purposes are segmented into Community Leaders and Thought Leaders. A community leader partner is an individual or entity known for using their national, local, or community level influence to mobilize individuals for social change. This includes social movement activists, influencers, organizers, corporations, nonprofits, and politicians. Thought Leaders are individuals or entities known for using their national, local, or community level influence to educate others on social issues and spread social awareness. This includes nonprofits, research centers, data centers & databases, professional scholars, and independent researchers. The details of each partnership will be negotiated at the time of creation.

### 7) Accordion Advertising & Marketing Model

Phaction innovates the ad process by prioritizing fairness, equal competition and ad quality over the bottom line. The Accordion Marketing Model connects ad purchase value to the likelihood of ad placement for segments or groups of similar ad partners. For success, the model will cater to, and favor, all ad partners regardless of circumstance and constraints.

The Accordion Marketing model optimizes marketing campaigns hosted on Phaction based on ad partner needs, advertising budgets, and philanthropic activity. The accordion marketing model begins with the configuration of the ad partner's marketing channel. In the ad partner marketing channel, ad partners agree to all Phaction Terms and Agreements, define their ad partnership type and purpose, set initial marketing budgets, and configure marketing campaigns. Marketing campaigns are separated into two components, philanthropic campaigns and ad campaigns. Once setting a complete marketing campaign budget, ad partners are required to set a minimum of 8%-12% of their complete marketing budget aside for their philanthropic campaign. The remaining funds, at maximum 88%-92% of market campaign budgets, are used for ad campaigns.

Within philanthropic campaigns, budgets are split evenly as donations to philanthropic entities partnered with or sponsored by the ad partner and donations to Clarintel. For donations to sponsored or partnered philanthropic entities, Phaction will independently create, or collaboratively work with ad partners to manage donation based, philanthropy focused marketing content that will be publicized by Phaction, Clarintel, media sources, and social sector partners. Donations made to Clarintel Inc. will be used to incentivize individuals to engage with ads on Phaction through the use of Equicoins. When Phaction members engage with ads and fulfill ad objectives, Phaction members receive Equicoins, on behalf of the ad partner, proportional to the ad partner's donation to Clarintel Inc. Phaction members can use Equicoins for donations to philanthropic prestige accounts and DACs hosted on Phaction. Since the donation is given to Clarintel, Clarintel fulfills the donation to philanthropic entities or DACs on Phaction. Clarintel maintains a record of Equicoins provisioned to Phaction members in relation to ad partners' philanthropic campaign budget.

As mentioned above accordion ad campaigns receive at most 88%-92% of complete market channel budgets. Through Accordion ad campaigns, ad partners are able to enhance their auction strategies, increase their chances of objective fulfillments and ad placement, and optimize their marketing campaigns through the selection of one of five ad models that best fit their objectives and bid strategies. Each ad model contains different features and measures for increasing ad placement specificity, audience precision, and streamlined objective fulfilment. Regarding auctions, each ad partner may only compete against those sharing similar qualities including, but not limited to: ad models, partnership types, ad track objectives, ad campaign budgets, and other factors discussed below. Phaction provides the ability for ad partners to increase likelihood of ad placement and the efficiency of ad campaign strategies by purchasing audience, campaign, and optimization targets specific to each ad model. Depending on the targets purchased by ad partners to specify ad campaigns within the associated ad models, Phaction further reduces the amount of competitors faced by ad partners per auction. In addition, each target used by ad partners during auctions directly increases their bid. This provides ad partners with the flexibility to enact auction strategies that reduce competitions, enhance audience specificity, and optimize budgets in accordance with ad track objectives. As ad partners upgrade their ad models, they are provided with enhanced capabilities and opportunities to optimize, enhance, and diversify their ad campaign strategies, approaches, and budgets.

The Accordion auction is built to prioritize ad placement based on the audiences that are more likely to engage with ad content, generate conversions, and fulfill ad objectives. Phaction members, or audiences, are organized into auction rooms based on likelihood of engagement, likelihood of conversions, and combinations of targets purchasable by ad partners including, but not limited to: audience, optimization, and campaign targets. In alignment with Phaction's ethical monetization principles, Phaction allows ad partners to automatically or manually enter auction rooms based on their selected ad model, budgets, purchased targets, strategies, ad track objectives, and other similarities. Phaction provides ad partners with control over their ad spending by incorporating a pay-for-performance model for all accordion auctions and auction rooms. Before joining an auction room and entering an auction, ad partners must upload a payment method, configure their bid strategy and limits, and set a budget cap, an amount dictating the ad partners maximum ad campaign budget or spending limit. To ensure that ad partner objective fulfillments align with ad spending, ad partners pay the winning bid amount per each objective fulfillment, or action, obtained from an ad placed on Phaction. Ad partners can track placed ad activity including, but not limited to objective fulfillments and ad spending from within their respective marketing channel. At the end of each month, ad partners are charged for the total amount of objective fulfilments garnished from placed ads. Depending on ad track objectives and auction success, ad partners may pay Phaction an amount that is lower than the budget set within their ad campaign. The accordion auction runs continuously and ad partners are consecutively placed in auctions until their ad track objective is fulfilled, their budget is depleted, their spending limit is reached, or it otherwise specified within the ad partners' ad track.

FIG. 2 illustrates an example Accordion marketing model.

### Ad Partner Marketing Channels & Campaigns

Ad Partner Marketing Channels are control centers for marketing campaigns. Marketing campaigns executed on Phaction consist of two parts, ad campaigns and philanthropic campaigns. Each marketing channel consists of foundational information needed to create, configure, execute, manage, and track all marketing campaign ads, ad decks, ad activity, auction activity, and objective fulfillments. Within marketing channels, ad partners have the ability to:

A. Configure, track and analyze marketing campaign activity, individual ad and philanthropic campaign activity, ad insights, and auction activity including but not limited to objective fulfillments, placed ads, audiences and demographics, and the state of current auctions.

B. Analyze and regulate ad budgets, philanthropy budgets, auction bids, and ad spending.

C. Create and manage ad models, ad tracks, and ad packages.

D. Utilize campaign, audience, and optimization targets to enhance auction strategies, auction groupings, ad placement, ad spending, and audience specificity.

### Ad Partner Criteria

Before creating a marketing channel, all ad partners must fit the below criteria:

A. Each ad partner must publicly support a philanthropic venture or social issue aligning with Clarintel and Phaction impact areas.

B. Each advertisement must be connected to a philanthropic entity or philanthropic opportunity for inclusion in accordion auctions.

C. All ad partners are required to create a Phaction account prior to partnership consideration.

D. Ad spend budgets over a specific amount will require the advertising partner to satisfy additional criteria that will be decided at a later date.

Phaction &Ad Partner Public Guarantee

In association with the above ad partner criteria, Phaction and ad partners publicly guarantee that:

A. All ads shown on Phaction will publicly support philanthropic opportunities, promote racial equity entities, or spotlight active social issues aligning with Clarintel Inc. impact areas, Clarintel, Phaction, and all associated partners.

B. Clarintel ensures that a minimum percentage of all ad revenue is donated to philanthropic entities. This will also be publicized through Clarintel Inc.

### Ethical Monetization Principles

Phaction's accordion advertisement structure serves as an equity engine; incentivising all ad partners to assist change agents in promoting and amplifying social action and philanthropy for social equity. To issue in a world built on equity, Phaction and ad partners both agree to uphold the following ethical monetization principles:

A. Fairness—We believe that all ad partners should have an equal opportunity for ad placement and objective fulfillments.

B. Care—We aim to promote empathy and concern for others of all backgrounds by incorporating philanthropy and social advocacy in all advertisements.

C. Transparency—We aim to be straightforward and concise in our communications about philanthropic partnerships and those that benefit from each advertisement.

### Marketing Channels & Campaigns

Marketing campaigns are managed within ad partner marketing channels and allow ad partners to control ad campaigns and philanthropic campaigns hosted on Phaction. Each marketing campaign consists of at least one philanthropic campaign for every ad campaign. Marketing campaigns consist of marketing campaign objectives, campaign budgets, ad partner specific details, and general audience demographics and details.

### Marketing Campaign Objectives

Phaction believes that the time has come for all corporations to take a stand against social issues. As part of the accordion marketing model, all ad partners are required to provide an internal written objective directed towards social action and change that is separate from their ad and philanthropic campaign objectives.

### Campaign Budgets

When creating a marketing campaign, it is mandatory for ad partners to configure three campaign budgets: a marketing campaign budget, a philanthropic campaign budget, and an ad campaign budget. Each budget allows ad partners to track their ad spending on a granular level. Phaction provides ad partners with full control over the management and optimization of budgets within their respective marketing channels.

A. Marketing Campaign Budget: The total amount of funds dedicated to both philanthropic and ad campaigns.

B. Philanthropic Campaign Budget: 8%-12% of marketing campaign budgets as designated by ad partners.

C. Ad Campaign Budget: 88%-92% of marketing campaign budgets as designated by ad partners.

### Ad Partner Specific Details

All ad partners can configure and manage logistical information pertaining to ads including but not limited to marketing leads, admin access and permissions, partnered entities outside of Phaction and Clarintel, marketing campaign objectives and goals, tracking measures, and general insights used for the associated philanthropic and ad campaign.

A. Partnership Details: Ad partners are able to view their partnership details including agreements, contracts, tax related files, and other business documents.

B. Philanthropic Partners: Ad partners can manage the philanthropic ad partners affiliated with their marketing and philanthropic campaigns.

C. Advertising Partners: Ad partners can manage their partners outside of philanthropy, such as partnerships with creative agencies, marketing entities, and other ad partners.

D. Current Following and Audience Insights: Ad partners can view marketing specific insights regarding their current following and audiences collected from their Phaction Account activity.

### General Audience Demographics and Details

Ad partners can also configure audience targets that apply to both ad campaigns and philanthropic campaigns. Audience targets are discussed later in this document.

### Philanthropic Campaigns

Philanthropic campaigns are publicized donations made to philanthropic entities or a Clarintel specific impact area as a mandatory part of individual marketing campaigns. Ad partner donations for philanthropic campaigns consist of 8%-12% of market campaign budgets. Donations will be split evenly between philanthropic entities partnered with or sponsored by ad partners and Clarintel Inc. Donations made to philanthropic entities by ad partners will be promoted via Clarintel, Phaction, and other information channels utilized by Clarintel and Phaction. Donations made to Clarintel will be used to incentivise Phaction members to engage with or fulfill conversions for placed ads associated with the respective ad partner. Philanthropic campaigns are mandatory for all ad partners excluding philanthropic organizations and similar entities. The individual components that frame philanthropic campaigns are below.

### Automatic Donations to Philanthropic Entities

For inclusion in the accordion auction, it is mandatory for all entities to dedicate 8%-12% of their market campaign budget to philanthropy. For each marketing campaign, ad partners must select the philanthropic entities that will be included in donation reception. All philanthropic entities selected, besides Clarintel, must also be spotlighted within the ad or ad decks offered for auction. If ad partners select Clarintel as their philanthropic entity, do not have philanthropic entities within their ads, and still highlight social issues, then all donations will be sent to Clarintel Inc.

### Philanthropic Activity Promotion

Following donation reception and provisioning to philanthropic entities supported by the ad partner, both Phaction and Clarintel utilize internal, external, and partner information channels to promote all philanthropic activity enacted by the ad partner. All marketing strategies executed for philanthropic activity will be decided on by both Phaction and the respective ad partner upon donation reception. Promotion endeavors enacted by Clarintel and Phaction will depend on philanthropic campaign budgets and be negotiated at the time of promotion execution.

### User Incentivizes for Ad Engagement and Conversions

In addition to Philanthropic Activity Promotion, donations to Clarintel Inc. will be used to incentivize Phaction members to engage in ad partner ad content. When an ad partner donates to Clarintel, all funds used for incentives are stored in a separate reserve for ads placed on the Phaction App in respect to the ad partner. When an ad partners' ad is placed on the Phaction App, members are incentivised to either fulfill an engagement or conversion by receiving a certain amount of Equicoins, or Clarintel reserved funds, relative to the ad partner's philanthropic campaign budget. Phaction Members can use Equicoins to donate to other philanthropic entities on Phaction or save them for rewards that will be decided at a future date. Donations made using Equicoins by Phaction Members to philanthropic entities and offerings on the Phaction App will be fulfilled using funds from the ad partners reserve stored in Clarintel Inc. The ad partners fund stored by Clarintel Inc. will be reduced based on the amount of associated Equicoins given to a Phaction Member for engaging with the ad partners' ad placed on the Phaction App. Ad partners have complete control over the amount of funds donated to Clarintel Inc. for incentives and the amount of Equicoun given to each individual member on Phaction app for engaging with their ad content and fulfilling their ad objective.

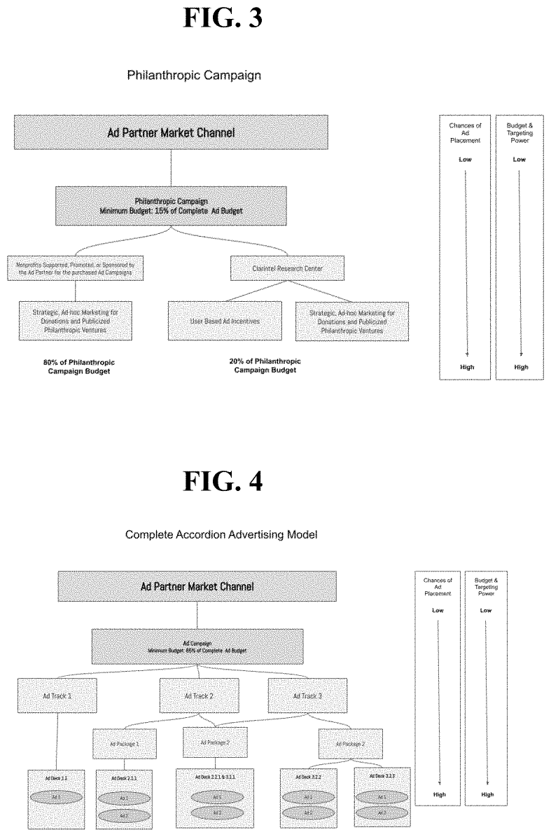

FIG. 3 illustrates an example philanthropic marketing model.

### Accordion Ad Campaigns

Accordion ad campaigns are the primary means by which ad partners configure and promote marketing material on Phaction. Ad campaigns consist primarily of ad tracks, ad models and a variety of packaged marketing targets. The structure of each component provides ad partners with complete control over their ad spending and objective fulfillments. To run an ad campaign, ad partners must first create an ad track. Given the ad objective stated in the created ad track, ad partners can select from a set of ad models that cater to their overall objective and audience specifications. Upon selecting an ad model for optimizing auction strategies, ad partners are provided with additional tools for enhancing ad campaigns including but not limited to ad packages and ad decks. As discussed in the abstract, the accordion ad model and auctions are structured to holistically favor engagements and conversions over impressions and reach. The below section discusses the components of accordion ad campaigns and the control provided to ad partners through the optimization of targeted groupings.

FIG. 4 illustrates an example Accordion advertising model.

### Ad Track Configuration

As stated above, each ad partner is required to create an ad track prior to auction entry. Ad tracks contain specific campaign details used to accurately place ad partner content on the Phaction App and measure ad fulfillments. In addition, ad tracks act as controllers for ad decks, or groups of ads, and provide additional tools for optimizing ad spending. Ad tracks contain the ad track objective, auction group, ad track philanthropic partners, ad track budget, and ad track daily spending limits. Ad partners also have the option to create and execute more than one Ad Track at a time if they have unique objectives and are eligible for the Platinum ad model. Ad partners that purchase additional ad tracks are responsible for setting appropriate ad track budgets, philanthropic partners, and associated daily spending limits.

### Ad Track Budget

The ad track budget is directly reflective of the ad campaign budget. The only instance in which this differs is if an ad partner hosts multiple ad tracks at once. In this case, ad partners can designate any amount of funds to an ad track budget adding up to the total ad campaign budget. Ad track budgets are only reduced by the winning bid following the placement of an ad and fulfillment of the ad track objective. Ad partners can track ad-track budget activity and set alerts for ad spending within their respective marketing channels. In addition, once ad track budgets are depleted, ad partners can either end their ad track or renew their ad track budget via their marketing channel.

### Ad Track Spending Limits

In addition to ad track budgets, ad partners have the ability to set daily, weekly, and monthly spending limits on their ad track. Setting spending limits on ad tracks provides ad partners with the ability to optimize their overall ad spend based on necessity. If no ad track spending limit is set, Phaction will continuously place ads at the most optimal bid per auction based on ad partner settings.

### Ad Track Auction Time Period

Phaction allows ad partners to specify the time periods in which they would like to enter auctions. If a time period is specified, ad partners will only be included in auctions during the specified time period. If no time period is set, Phaction will continuously enter an ad partner into auctions until either the ad track spending limit is reached, the ad track budget is depleted, or the ad track objective is fulfilled.

### Ad Track Philanthropic Partners

Ad partners are provided with the ability to designate philanthropic partners for each ad track. If only one ad track is used, then all philanthropic partners designated in philanthropic campaigns will also be attributed to ad tracks. If an ad partner uses multiple ad tracks, then the ad partner is responsible for designating philanthropic partners per ad track. Otherwise, Phaction will associate all philanthropic partners with all active ad tracks. Associating philanthropic partners with ad tracks allows Phaction to automatically target current audiences associated with existing philanthropic entities, thus increasing the chances of engagement and objective fulfillments. In addition, by directly associating philanthropic partners with ads, ad partners are able to increase the societal impact of each ad and dramatically enhance ad recognition and satisfaction. All ad partners are required to partner with at least one philanthropic entity prior to the execution of an ad track. In this case that an ad partner outside of Clarintel is not associated with an ad track, Clarintel Inc. can be included as an option for philanthropic partnership given that all ads within the ad track satisfy Clarntel criteria.

### Ad Track Objectives

Phaction allows ad partners to select ad objectives from a list of designated outcomes tracked via the Phaction App. It is mandatory for ad partners to set an ad track objective for every ad track in alignment with the respective marketing campaign objective. The ad track objective serves as the means for tracking progress towards the overall fulfillment of marketing objectives outside of philanthropic campaigns. Ads will remain in auction until ad track objectives are fulfilled. Analytics and insights for tracking progress towards ad track objective fulfillment can be found within the ad partners' marketing channel. Ad partners can choose from the below list of ad track objectives. This list will be expanded given further research and development. The list includes, but is not limited to: Engagement, Conversions, Impressions (Local, Community, National), Reach (Local, Community, National), Video Views, Phaction Page Views, Website Views, Website Clicks, Gestures & Reactions, Conversations and Responses, Replies and Comments, App Installs, Philanthropic Presence, Philanthropic Expansion, Philanthropic Engagement, Philanthropic Conversions, Pattern Development, Donations, Petitions Signing, Pledge Commitments, Volunteer Sign Ups, Participant & Attendee Sign Ups, Philopic Views, Philopic Clicks, Phaction Page Visits, Mentions & Tags.

### Ad Track Groups

Ad partners must also select an ad track group for auction purposes. Ad track groups on Phaction reflect the effect that ad partners aim to have on society and allows Phaction to further organize and optimize auctions based on social and market conditions.

A. Social Capital: Ad partners aim to increase their social presence and social influence.

B. Social Action: Ad partners aim to enhance or drive their engagement or the public's engagement in social action.

C. Social Impact: Ad partners aim to increase the scope, scale, or strength of their own or their audiences' social action approaches and impact on society outside of influence.

D. Social Awareness: Ad partners aim to spread awareness about social issues and racial equity related topics.

### Ad Track Audience Targets

Ad partners have the ability to purchase targets for minimizing or expanding their reach based on audience specific qualities. Each audience target cost between $0.01 and $0.05 and counts towards auction bids for ad placement. Ad partners are only charged for audience targets used on placed ads that achieve ad track objective fulfillment. Audience targets available for purchase include, but are not limited to:

A. Cultural Affiliation: The audiences ethnic, national, and cultural affiliations as stored in Phaction accounts.

B. Geolocation: The latitude and longitude of the audience's current location.

C. Zip Code: The current zip code of the audience.

D. Region: The county, city, state of the audience.

E. Locale Code: The locale code of the audience.

F. Race: The audience race as stored in Phaction accounts.

G. Language: The language that an audience speaks or uses in the Phaction App.

H. Personality Type: The Myers Briggs personality type as stored in Phaction accounts.

I. Philanthropic Role: The philanthropic role held by Phaction members.

J. Zodiac Sign: If enabled by the Phaction member, then Phaction will provide the zodiac sign of audience members, as calculated from audience member birthdays.

K. Religious Affiliation: If enabled by the Phaction member, then Phaction will provide the religious affiliation of audiences as stored in Phaction accounts.

L. Age: The current age or age range of Phaction's audience as calculated by the birthday saved in individual Phaction accounts.

M. Gender: The gender identification, including non-binary options, as stored in the Phaction account.

N. Pronouns: The pronouns that the audience uses to identify on Phaction.

O. Device Model & Mobile Carrier: The device model and mobile carrier of the device or phone that a Phaction member is using to access the Phaction app.

P. OS Version: The operating system version of the audience's device.

Q. Socioeconomic Status: An audience's educational status including college major, college minor, income, occupation, political stance and affiliations, home & home value, and work positions

R. Platform: 4G, 5G, Wifi usage by the audience device

S. Inclusive Targeting: Ad partners can increase the size of their campaign audience by including any of the targets above.

T. Exclusive Targeting: Ad partners can optimize ad strategies and target specific audiences by excluding any of the targets above.

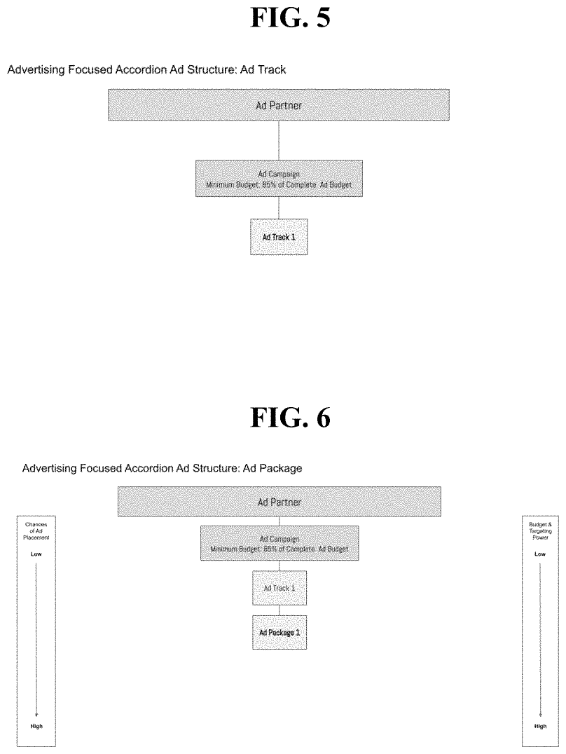

FIG. 5 illustrates an example advertising focused Accordion advertising structure, in accordance with one or more embodiments.

### Ad Package Configuration

Ad partners can increase audience specificity and likelihood of ad placement by purchasing ad packages. Ad Packages are collections of organized campaign targets, metrics, data, and insights, used to enhance audience precision and ad targeting. Campaign targets purchased by an ad partner directly increase the chances of ad placement by minimizing the amount of competitors faced for specific audience groups. As a default, Phaction will automatically show ad's to audiences more likely to engage with ad content, fulfill ad objectives and conversion, and consider ads as relevant and interesting. Individual activity generated for purchased campaign targets will be displayed in the ad partners market channel for analysis and tracking. Ad partners can change campaign targets used in ad packages and auctions at any time to modify their bid and audience specificity. In addition, ad partners have the ability to automatically randomize groups of campaign targets used in each auction, thus providing flexibility and adaptability for gaining exposure from different audience groups per auction. Unlike audience targets, however, ad partners pay for campaign targets used on placed ads.

### Campaign Targeting Through Ad Packages.

A. Interest & Philopics: Ad partners can choose from thousands of philopics and philopic categories spanning various social issues, philanthropic entities and other categories of interest.

B. Mirrors: Mirror Targeting allows ad partners to target audiences with interests and behaviors similar to their account friends and champions. Ad partners can add mirror accounts by entering the specific account username or @, and then adding all similar accounts to their target audiences.

C. Connections: Ad partners can add or exclude existing friends, champions, and other Phaction accounts from the ad target audience.

D. Keyword: Ad partners can target Phaction members based on keywords from search queries, posts, fulfilled DACs, recently engaged Phaction Pages, comments and viewed content. After setting a keyword, ad partners can either include audiences that use the selected keywords with high frequency to their target audiences or exclude them. If the Phaction member engages with or utilizes the keyword in any way on the Phaction App and meets additional audience specifications including location, demographics, language, and device, then they will be added to the ad partners target audience. Otherwise, they will be excluded from the target audience.

E. Event: Ad partners can target specific events to proactively plan and quickly execute ad campaigns in response to social issues, causes, events and philanthropic occurrences.

F. Conversation: Ad partners can choose from thousands of philopics to target Phaction members participating in or viewing a specific conversation or topic.

G. Social Issue Conversation: Ad partners can choose from thousands of social issue and philanthropy specific philopics and keywords to target an audience participating in or viewing specific social issue conversations.

H. Nonprofits and DACs: Ad partners can target specific events, responses, and actions incurred by philanthropic entities and DAC's on Phaction.

I. Actions: Ad partners can add individuals that recently conducted a specific action on the Phaction App.

J. Philopic Targeting: Ad Partners can choose from all philopics listed on Phaction to specify or expand audiences based on interest.

K. Behavioral Pattern Targeting: Ad partners can target behavioral patterns exhibited by Phaction members while using the Phaction app. This information is recorded over time for all Phaction members.

L. Belief Targeting: Ad partners can specify audiences based on belief systems including but not limited to religion, zodiac, and personality types.

M. HERR's: Ad partner can target the historical emotional response & reaction noted for specific audience groups of audiences. Activation of this target pends a semantic analysis of ad and platform content that reflects human emotion.

N. Trend Targeting: Ad partners can specify audiences based on societal trends including but not limited to ideological shifts such as changes in cultural, market, and social conditions.

O. MoM Donations: Ad partners can specify audiences based on Phaction members month over month donations to philanthropic entities.

P. Supported Stances: Ad partners can specify audiences based on the social causes and ventures consistently or publicly supported by Phaction members for ad placement.

Q. Social Activity Targeting: Ad partners can specify audiences based on general platform activity including but not limited to content engagements and types, engagement frequency, active and inactive times, and influence.

R. Philanthropic Activity: Ad partners can specify audiences based on activity specific to philanthropic engagement including but not limited to donations, user incentivized ad completion, and DAC engagements, conversions, and interactions.

FIG. 6 illustrates an example advertising focused Accordion advertising structure, in accordance with one or more embodiments.

### Ad Preparation and Configuration

After configuring an ad track, ad partners can upload ad content in sets called ad decks for auction inclusion. In addition to uploading ads, ad partners must configure bid per ad or bid per ad deck and their automated bid strategy. Ad partners can also purchase optimization targets for each ad deck to increase their chances of achieving objective fulfilments. After configuring an ad deck, ad partners are provided access to auctions based on their selected ad model. This section discusses ads, ad decks, and the components offered to ad partners for optimizing, enhancing, and controlling their marketing approaches.

### Ads & Ad Decks

Whenever ad partners upload ads onto Phaction, the ad is stored in an ad deck. On Phaction, ads are individual, creative content items managed and uploaded by ad partners to promote their material. Ad Decks are groups of one or more ads used in alignment with an ad partners' ad track objective. Ad decks are composed of ads and are the primary means by which the accordion model functions. Ads stored in ad decks are entered into auction in the order they are uploaded or in the order of priority as set by the respective ad partner. As stated before, ad partners only pay the full auction bid amount if their ad wins the auction, is placed on the Phaction App, and achieves an objective fulfillment.

### Bid Thresholds for Ads and Ad Decks

Phaction provides ad partners with the option to either set bid thresholds for ad decks or bid thresholds for each individual ad uploaded to Phaction. Bid thresholds allow ad partners to control their minimum and maximum ad spend per ad. If an ad partner sets a bid threshold on an ad deck, then all ads within the ad deck will be given the same bid threshold regardless of auction grouping. If an ad partner chooses to set a bid threshold on each individual ad, then bids placed at auction will reflect the ad partner preferences. Ad partners can also set bid thresholds per auction grouping as dictated by ad models, audience specificity, and purchased targets. Minimum and maximum bid amounts per auction group will be governed by ad partner specific details as discussed in the Ad Models section of this document.

### Optimization Targets

Ad partners can increase their chances of ad placement, the probability of objective fulfillments, and optimize their ad campaigns by targeting audiences based on specific audience actions and behaviors. This targeting mechanism differs from campaign and audience targets by allowing ad partners to target the Phaction members most likely to fulfill ad target objectives based on optimization targets. In other words, optimization targets allow ad partners to specify actions or outcomes in alignment with their marketing and ad track objectives. Each optimization target increases ad bids between $0.07 and $0.12 depending on the chosen optimization target and amount of targets selected.

Optimization targets offered by Phaction include, but are not limited to: Reach, Impressions, App Installs, Page Views, Taps, Gestures, Conversations, Website Clicks, Conversions, Donations, Commitments, Sign Ups, Attendees, Engagements, DAC Page Visits, DAC Conversions, Repeated Behaviors, and Philanthropic Activity.

### Bid Strategies

Each automated strategy below prioritizes the optimization of ad partner bidding based on necessity and budget.

A. Automated Bidding: Automated bidding is the default auction strategy for all ad partners. This strategy focuses on spending the full ad budget as fast as possible while maximizing campaign results.

B. Cost Control Bidding: Cost Control bidding directs ad partners to auctions that maximize objective fulfillments at the lowest cost while still falling within partner ad budgets. This strategy allows ad partners to control ad track budgets and results by setting low bid per ad limits.

C. Rush Bidding: Rush bidding focuses on spending ad track budgets as fast as possible while maximizing the likelihood of ad placement.

D. Ceiling Bidding: This bid strategy allows ad partners to optimize auction strategies by setting the maximum bidding amount for each ad placement or objective fulfillment. When a ceiling limit is placed on a bid, Phaction will not place a bid for the ad partner over the ceiling limit placed.

E. Optimized Value Bidding: Value bidding is a form of bidding that focuses on higher value conversions and engagements that align with marketing and ad track objectives. This optimizes bidding by focusing on higher value auction groups.

F. Action Focussed Bidding: This type of bid allows ad partners to place bids based on the specific action they would like to receive by Phaction members per ad deck aligning with their respective ad track objective.

G. Minimum Return: This strategy provides ad partners with enhanced control over the purchase value, or estimated worth, generated from each ad. This measure focuses the outcome and allows ad partners to prioritize break-even ad spending strategies by aiming to reach a certain return on each ad.

H. Response Triggered: Response triggered bidding focuses on entering ads into auctions that attract audiences affected by social issues or related events during specific time periods or following specific social issues occurrences. With this strategy, ad partners are able to set bid limits given specific events.

I. Custom Bid Caps: Ad partners can set custom bid caps for complete control and management of all ad bidding strategies for each auction and auction group. This is key for ad partners applying internal bidding strategies or ad hoc and custom advertising models.

### Ad Content Types

Ad partners can upload different types of ad content to Phaction for promotion. The types of ad content that ad partners can upload to Phaction include, but are not limited to:

A. Pheed Ads: These are ads shown on different Phaction pheeds. Ads included in pheeds are formatted as text, phlix, phruit, or DAC posts. Pheed ads live for the lifetime of the pheed.

B. Pheel Ads: These are ads shown between Phaction member pheels and are generally videos or short ads meant to quickly catch audience attention. These ads are removed after 24 hours.

C. Phaction Pages: Phaction allows ad partners to purchase Phaction pages for executing additional promotional measures for current philanthropic endeavours or marketing campaigns. Once the page is created, it is stored in a Page Deck associated with the ad partners Phaction account. The lifetime of these ads depends on the duration set by the ad partner when configuring the Phaction Page.

D. Philanthropic Ads: These ads are displayed in association with philanthropic content and DACs hosted on Phaction. Philanthropic ads may be in the form of popups, pictures, or videos and are only removed upon complete objective fulfillment.

### Ad Model Selection

Once setting an ad track, ad partners can select one of 5 models from which to build, execute, and track their ad campaigns: Gold, Diamond, Double Diamond, Platinum, or Black Platinum. Ad models are used to fairly group ad partners based on ad spending, audience specifications, and marketing strategies. In addition, the chosen ad model dictates the type and amount of purchasable targets offered to ad partners, the size of the auction competition pool, the maximum bid per auction, and the likelihood of objective fulfillments. In the auction process, ad partners compete against fellow ad partners within the same ad model unless special circumstances arise where a partner utilizes a custom model.

### Gold Model

The Gold Model is Phaction's standard and most cost efficient ad model. This model is for ad partners that do not necessarily know their objective or outcome and want to quickly execute their ad campaign. After setting an ad track, ad partners can immediately create ad decks and join the gold auction room. Ad Partners within the Gold Model can purchase and apply any amount of ads and ad decks to increase chances of success and ad precision. However, the Gold Model is limited in the amount of campaign, optimization, and audience targets that an ad partner can purchase.

Gold Model Components & Limitations:

A. Ad Tracks: 1

B. Ad Packages: Not Available

C. Amount of Audience Targets Available for Purchase: Up to 9

D. Amount of Optimization Targets Available for Purchase: Up to 3

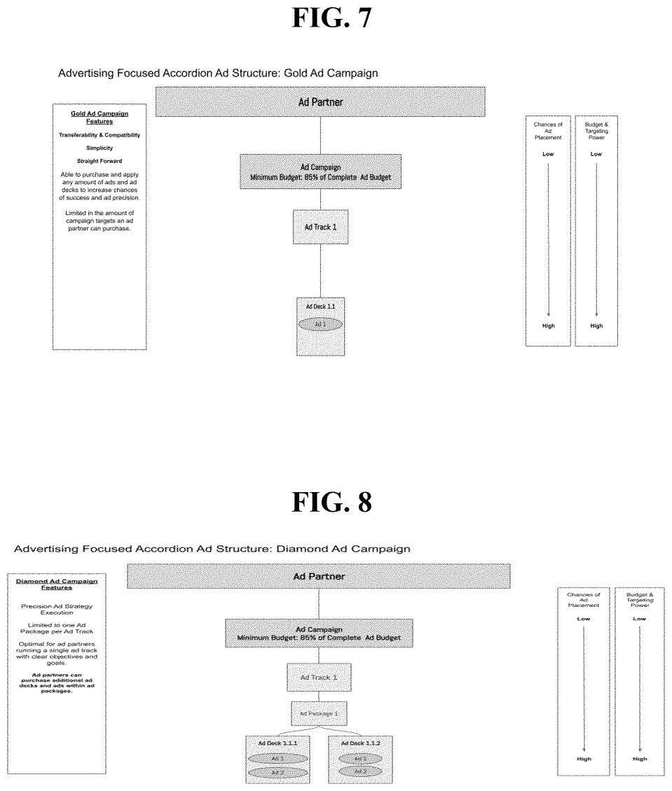

FIG. 7 illustrates an example advertising focused Accordion advertising structure, in accordance with one or more embodiments.

### Diamond Model

The Diamond Model acts as an enhancement to the Gold Model by including Ad Packages. Phaction applies Ad Packages to Ads and Ad Decks prior to auction. In doing so, Phaction is able to increase the likelihood of ad placement by allowing ad partners to only compete with other ad partners containing similar audience specifications and targets. When more campaign targets are purchased by an ad partner, there is a decrease in auction competition, and an increase in the chances of ad placement, audience accuracy, and the likelihood of ad track objective fulfillment. This model is limited to one ad package per ad track and is optimal for ad partners running a single ad campaign with clear objectives and goals.

Diamond Model Components & Limitations

A. Ad Tracks: 1

B. Ad Packages: 1

C. Amount of Audience Targets Available for Purchase: Up to 12

D. Amount of Campaign Targets Available for Purchase: Up to 9

E. Amount of Optimization Targets Available for Purchase: Up to 5

FIG. 8 illustrates an example advertising focused Accordion advertising structure, in accordance with one or more embodiments.

### Double Diamond Model

The Double Diamond Model is an upgraded version of the Diamond model. In the Double Diamond Model, an ad partner can create multiple ad packages with independent ad decks under a single ad track. In this model, ad partners can precisely target multiple audiences at once while executing different marketing strategies dedicated to fulfilling the same ad track objective. Ad partners can also purchase additional ad decks within ad packages to enhance the flexibility of their marketing approaches. This model is useful for ad partners running an ad campaign with different types of ad content for multiple philanthropic ventures at once.

Double Diamond Model Components & Limitations

A. Ad Track: 1

B. Ad Packages: No Limit

C. Amount of Audience Targets Available for Purchase: Up to 15

D. Amount of Campaign Targets Available for Purchase: Up to 12

E. Amount of Optimization Targets Available for Purchase: Up to 7

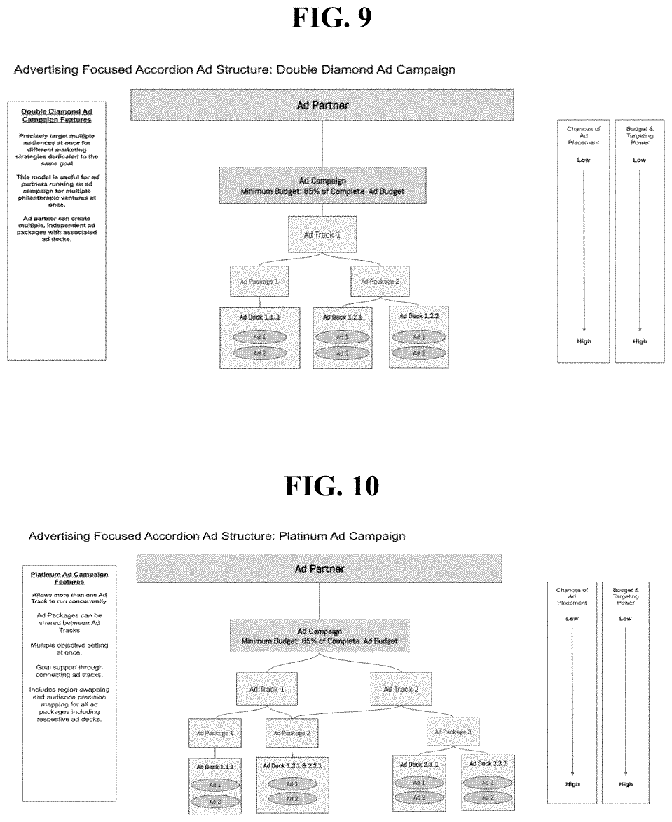

FIG. 9 illustrates an example advertising focused Accordion advertising structure, in accordance with one or more embodiments.

### Platinum Model

Unlike the above models, the Platinum Model allows ad partners to concurrently execute more than one Ad Track. In this model, ad packages can be shared between ad tracks. This allows ad partners to optimize their ad spending and presence by running multiple independent campaign strategies at once, all with independent objectives and targets for advanced audience precision. Ad partners will be charged appropriately for ad package connections and additional ad tracks. This option includes region swapping and audience precision mapping for all ad packages including respective ad decks.

Platinum Model Components & Limitations

A. Ad Tracks: No Limit

B. Ad Packages: No Limit

C. Amount of Audience Targets Available for Purchase: Up to 18

D. Amount of Campaign Targets Available for Purchase: Up to 15

E. Amount of Optimization Targets Available for Purchase: Up to 10

FIG. 10 illustrates an example advertising focused Accordion advertising structure, in accordance with one or more embodiments.

Black Platinum Model

The Black Platinum Model is a complete, pay as you go ad hoc model that allows ad partners to combine all of the above models into a single ad campaign. This model is created and fully managed by partner entities. This is best for entities executing internal bidding strategies and auction models.

Black Platinum Model Components & Limitations

A. Ad Tracks: No Limit

B. Ad Packages: No Limit

C. Amount of Audience Targets Available for Purchase: Up to 18

D. Amount of Campaign Targets Available for Purchase: Up to 18

E. Amount of Optimization Targets Available for Purchase: Up to 12

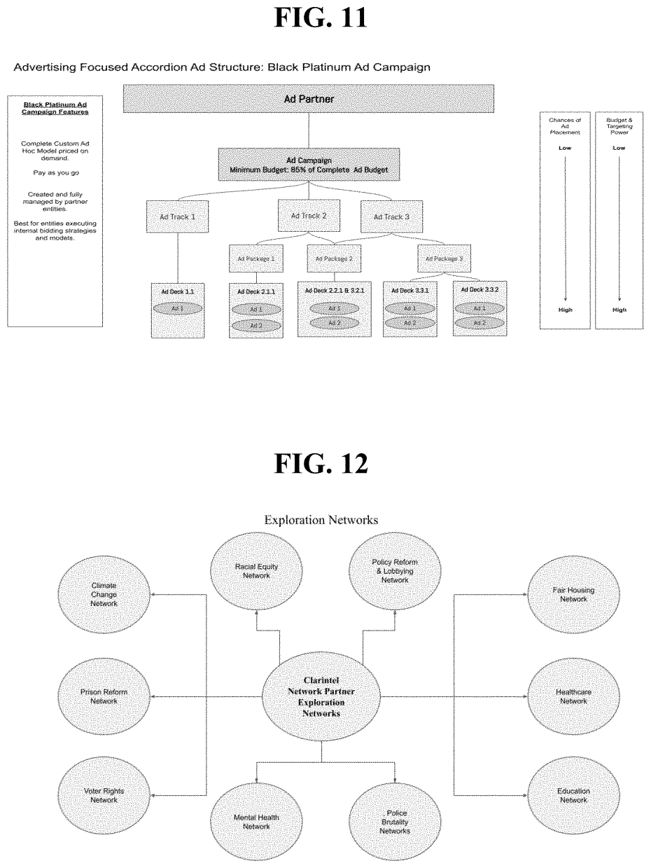

FIG. 11 illustrates an example advertising focused Accordion advertising structure, in accordance with one or more embodiments.

### The Accordion Auction Structure

Each accordion auction aims to uphold Phaction's ethical monetization principles during auction execution. To ensure that all auctions exemplify fairness, transparency, and care, Phaction creates auction rooms for executing individual auctions based on ad models and other factors designated by the ad partner prior to auction entry. When creating auction rooms, Phaction takes the following into consideration: ad partner budgets, ad track objectives, ad models, bid strategies, and audience specifications selected through sets of purchased campaign, audience, and optimization targets. Depending on the ad model chosen by ad partners, ad partners are able to compete for ad placement within individual auctions held in auction rooms that vary in the likelihood of engagement and conversion. The lifetime of ads placed through accordion auctions depends on the ad's content type and ad partners only pay for ad objective fulfilments; not for ad placement. The below section discusses how Phaction organizes auction rooms and executes individual auctions.

### Accordion Auction Rooms

Each accordion auction aims to uphold Phaction's ethical monetization principles during auction execution. To ensure that all auctions exemplify fairness, transparency, and care, Phaction creates auction rooms for executing individual auctions based on ad models and other factors designated by the ad partner prior to auction entry. When creating auction rooms, Phaction takes the following into consideration: ad partner budgets, ad track objectives, ad models, bid strategies, and audience specifications selected through sets of purchased campaign, audience, and optimization targets. Depending on the ad model chosen by ad partners, ad partners are able to compete for ad placement within individual auctions held in auction rooms that vary in the likelihood of engagement and conversion. The lifetime of ads placed through accordion auctions depends on the ad's content type and ad partners only pay for ad objective fulfilments; not for ad placement. The below section discusses how Phaction organizes auction rooms and executes individual auctions.

Ad partners are permitted entry into accordion auction rooms based on the structure of their selected ad model, their partnership type, ad track group and objective, purchased targets, and ad content types. Each auction room that an ad partner enters determines the likelihood of objective fulfillment and audience engagement. The purpose of auction rooms is to ensure fairness of ad competition for all ad partners. Auctions run independently of one another for the attention of a specific portion of Phaction's audience based on targets, interests, and probability of impressions, engagements and conversions. The different types of auction rooms, auction room structures, and governing criteria are below.

### Gold Auction Rooms

Ad partners can enter Gold Auction Rooms if they select the gold model. Gold rooms are more general in their targeting due to the absence of ad packages and provide lower chances for action based objective fulfillments in comparison to other auction rooms. This room specifically favors audience impressions and reach objectives over specific audiences that are more likely to engage with ad content and generate conversions. In addition, this room has fewer audience and optimization targets to select from and therefore has fewer opportunities for reduced auction competition.

The amount of Gold Auction Rooms fluctuate based on the amount of ad partners competing for overlapping, active Phaction members, or audiences. Phaction builds gold auction rooms based on random assortments of unique ad track objectives, audience specifications, and ad content types. Since the gold model allows ad partners to choose one ad track objective from seventeen options, one optimization target, up to seven audience targets, and 4 content types, once removing duplicates, ad partners within the gold model have roughly 80,000 unique auction rooms to choose from for ad placement. Though auction rooms allow for individual Phaction members to be spread throughout multiple auction rooms for ad placement, Phaction ensures that individual member pheeds always favor original content over ads. For example, if an ad partner wins a platinum auction with a higher bid for the same individual that an ad partner won in a gold auction with a lower bid, then the ad partner's ad that won the platinum auction will be placed at times of higher engagement while the ad that won the gold auction will be placed at times of lower engagement. However, if the Phacion members' pheed has a high saturation of ads, then the respective audience member may only be included in platinum room auctions and not gold room auctions.

Gold Auction Rooms Details

A. This is the most affordable option for ad partners with the lowest bid threshold of, as examples, $0.00-$2.15.

B. These rooms favor smaller and newly developed entities.

C. Gold Auction Rooms generally contain larger competition pools compared to diamond and platinum auction rooms due to less targeting capabilities. In examples, Gold Auction Rooms may contain smaller audience pools depending on the amount of ad partners competing for ad placement in other auction rooms.

D. In Gold Auction Rooms, ads may be placed at times when the likelihood of audience engagement or conversion is the lowest in comparison to the diamond and platinum auction rooms; up to 45%. Because of this, these rooms focus on achieving impressions and reach.

E. Depending on the ad quality score determined at the close of auction and the winning bid, these ads may compete with ads from ad partners in other auction rooms and obtain ad placement at times when there is a higher likelihood of engagements and conversions.

F. Lifetime of placed ads depend on ad content type.

### Diamond Auction Rooms

Ad partners can enter the Diamond Auction Rooms if they upgrade from the Gold Model to the Diamond or Double Diamond models. These rooms provide enhanced audience specificity in comparison to Gold Models and Gold Auction Rooms. Through the addition of ad packages, ad partners are provided with advanced tools for obtaining higher value objective fulfillments, engagements, and conversions. By increasing the amount of targets used within each ad package, ad partners reduce their competition for specific audience groups and increase their chances of winning diamond auctions. As a default, Phaction ensures that all audiences targeted within Diamond Auctions have up to a 55% likelihood of ad content engagements and conversions. Since diamond auctions target specific audiences, Phaction judges ads based on relevance and relatability to the targeted audience in addition to default criteria discussed below.

Similar to Gold Auction Rooms, the amount of Diamond Auction Rooms depends on the amount of active audience members and ad partners competing for the same audience group based on similar qualities. Phaction places audiences into Diamond Auction Rooms by choosing active Phaction members that closely align or match with purchased targets organized and utilized by ad partners. In addition, Phaction members are placed into Diamond Auction Rooms prior to Gold Auction Rooms. This prevents the oversaturation of ad content and increases the likelihood of ad satisfaction. As mentioned above, placed ads won in Diamond room auctions are shown at higher times of engagement in comparison to those won in Gold Room Auctions.

Diamond Auction Room Details

A. This is the most affordable option that includes advanced targeting with a cost-efficient bid threshold of, as examples, $0.05-$2.75.

B. These rooms favor entities that are confident in their marketing strategies and know their audiences.

C. These rooms tend to have smaller competition pools due to advanced targeting capabilities.

D. In Diamond Auction Rooms, ads are placed based on times of average likelihood of audience engagement or conversion, up to 55%.

E. Diamond Auction Rooms audience pools vary in size depending on audience specificity.

F. Lifetime of placed ads depend on ad content type.

### Double Diamond Auction Walking

Ad partners can upgrade their Diamond Ad Models to Double Diamond for the enhancement of their ad campaign targeting strategies executed within Diamond Auction Rooms. As a Double Diamond Auction Walker, ad partners can create multiple ad packages for managing various ad decks focused on fulfilling the same objective. Upgrading to this model gives ad partners the flexibility to promote different ads and ad content types to multiple audiences at once for the diverse sharing of a unified message under a single ad campaign.

Double Diamond Auction Walking Details

A. This is the most flexible option with a bid threshold of, as examples, $0.10-$3.00.

B. These rooms favor entities that have higher budgets and the capability to execute and sustain multiple ad campaigns for multiple audiences simultaneously.

C. By upgrading to Double Diamond, ad partners have increased accessibility to auctions and can enhance the adaptability of their ad campaigns by executing audience and time-based auction strategies.

D. For Double Diamond Auction Walkers, ads are placed based on times when the likelihood of engagement is either average or above average, up to 65%.

E. For Double Diamond Auction Walkers, Diamond Auction Room audience and competitor pools may vary in size dramatically depending on auction specificity and target groupings.

F. Lifetime of placed ads depend on ad content type.

Platinum Auction Rooms

Similar to above, ad partners join platinum auction rooms if they select the platinum model during campaign creation. Platinum models allow ad partners to control multiple ad campaigns at once with the enhancements of the double diamond model. In addition, platinum auction rooms are structured similar to diamond auction rooms with enhanced audience specifications and increased chances of high value ad placements. Ads placed through platinum room auctions are shown at higher times of engagement and conversions in comparison to those placed in Diamond and Gold Room Auctions, at up to 75%.

Platinum Auction Rooms Details

A. This is the most strategic model set at a higher price point that includes all targeting options with a bid threshold of $0.20+.

Platinum auction rooms provide the most control over competition pools due to advanced targeting capabilities.

B. For Platinum Auction Rooms, ads are placed based on times of relatively high likelihood of audience engagements and conversions, up to 75%.

C. Platinum Auction Room audience pools vary in size depending on audience specificity.

D. Lifetime of placed ads depends on ad content type.

### Black Platinum Auction Walking

Ad partners that select the black platinum ad model have the ability to designate ad decks for any of the auction rooms mentioned above. Since black platinum ad partners create custom models, auction room selection depends on the custom model built to execute ad campaigns.

### Auction Group Enhancements Through Randomized Targeting

Ad partners that utilize numerous audience, optimization, and campaign targets can elect to automatically restructure the groups of targets used in auction by allowing Phaction to combine purchased targets into randomized sets that differ from auction to auction. This helps ad partners to enhance ad efficiency and expand their reach by applying different audience attributes within individual auctions.

### Winning the Auction Through Auction Scores

Regardless of the auction room, all ad placement depends on the ad partners Auction Score. Auction Scores are determined based on the ad partners bid and their ad deck quality score in relation to audience groups and auction room competition. As mentioned above, bid thresholds are dependent on the ad model and auction room chosen by the ad partner. Though the use of audience, optimization, and campaign targets directly increase auction bids, ad partners are not required to purchase targets and can independently bid in auction rooms until reaching the max bid for the respective room. If multiple ad partners reach the maximum bid threshold or have the same bid, the winning ad is determined based on its quality score. In alignment with Phaction's ethical monetization principles, Phaction always favors ad quality scores over the highest bid and reserves the right to place ads based on the highest ad quality scores rather than the highest bid amount. Ad partners can track auction status, view their ad deck quality scores prior to auction, receive insights on placed ads including audience activity and objective fulfillments, and manage their ad spend and auction strategies from their Marketing Channel.

### Ad & Ad Deck Quality Scores

As previously mentioned, each ad or ad deck uploaded to Phaction is provisioned with a score dictating the quality of the ad. The ad quality score signifies an ad or ad decks exemplification of each individual quality below including alignment with Clarintel and Phaction's mission, values, and objectives:

A. Relatability: Ad's likelihood to increase engagement and conversion rates.

B. Relevance: Ad's direct or indirect alignment with target audience interests.

C. Transparency: Ad's ability to clearly communicate philanthropic partnerships, advertisement beneficiaries and stance on social issues.

D. Freshness: Ad's connection and relation to current and upcoming occurrences and events.

E. Awareness: Ad's ability to promote and increase empathy, care, and concern within target audience's regarding social issues, social causes, and philanthropic entities.

F. Significance: Ad's public display of alignment with current social issues and philanthropic ventures.

G. Equity: Ad's promotion of inclusivity, representation, and equality.

### Paying for Ad Placement

Ad partners pay the amount of the winning bid for each action taken towards their ad track objective. Each billed objective fulfillment is tracked and managed from the ad partners marketing channel. At the end of each month, Phaction will charge the total amount of billable objective fulfillments to the payment method provided by the ad partner. Due to the structure of the accordion model, ad partners will never be charged more than the original budget set for their ad campaign. If an ad partner achieves their ad track objective or depletes their budget, they are automatically removed from auctions until further action occurs.

### Insights for Placed Ads and Purchased Targets

As previously mentioned, all ad partners have access to insights, analytics, and trends regarding ad content placed on Phaction. The insights provided to partners will be the same insights provided to Phaction members for each respective ad content type.

### 8) Clarintel, Inc

Clarintel Inc. is the point where all credible social issue data and racial equity entities converge. Clarintel's primary focus is to discover, collect and promote all data and information directly or indirectly related to or associated with racial equity focused social sector entities, social issues, and philanthropy. By centralizing all public racial equity information in addition to the application of internal research approaches, Clarintel enables and fosters strong relationships and connections between racial equity focused entities to master change based on the truth within data. Through this approach, Clarintel offers a new type of ecosystem built by connecting data sharing, philanthropic networks that provides all partners with the ability to securely view, exchange, utilize, promote, and track social issue related information, data, and resources with other credible entities fighting for change.

Outside of amplifying social impact by connecting racial equity entities to social issue data, Clarintel Inc. allows partners to access a variety of ad-hoc philanthropic and social sector focused cloud services and applications for revolutionizing approaches to planning, executing, and collaborating on social action and philanthropic ventures. By integrating with Phaction, Clarintel Inc. partners' can also access a variety of innovative channels, tools, and applications for promoting, streamlining, tracking, and managing shifts in ideology, audience specific public perceptions and semantics, social issues, philanthropic activity, audience insights, and societal impact. In alliance with Clarintel's mission, partners are provided with a dashboard for tracking and measuring insights, metrics, and analytics pertaining to audiences, network activity, content, and all information and data shared, saved, or exchanged through Clarintel and Phaction. The below document discusses the initiatives, services, and processes created, maintained, and applied by Clarintel Inc.

### Ad-Hoc Service Models:

Clarintel's services are created to redefine social sector collaborations, reinvent and strengthen the connection between data and social sector entities, and revolutionize social issue-based strategies, solutions, and advancements. Initially, Clarintel Inc. will only provide the below services to racial equity focussed entities and measure service efficiency for increased philanthropic operations and societal impact. Based on the success and feedback of each service, Clarintel will ultimately usher in a new era of social action and understanding built on data, collaboration, and unification. Each service model discussed below will be expanded and enhanced upon further development, research, and partnership endeavors.

### Information as a Service

Philanthropy and Social Issue News Source: After unifying and centralizing information and data from news entities, nonprofits, research centers, and other organizations dedicated to collecting and reporting on racial equity and related social issues, Clarintel Inc. will promote the collected information on a community, local, and national level. In addition, Clarintel will utilize its internal resources to both recruit and gather information from freelance reporters and activists operating within and reporting on areas impacted by racial equity related social issues. As part of our mission to promote and redefine social action through clarity and intelligence, Clarintel does not intend to take credit for any information shared through Clarintel's news media unless created, generated, or purchased by Clarintel and will always attribute content credit to the originating author and contributing entities.

Racial Equity Data Epicenter and Search Engine: Clarintel Inc. will create and host the largest publicly available database of historical and current racial equity data and information. The racial equity information collected and stored by Clarintel will align with the impact areas mentioned below and be categorized by location, entity type and size, issue longevity, demographics of the impacted population, and additional categories mentioned below, found through research, and provided through further direction from the board of directors. In addition, Clarintel will maintain a historical record of all active entities dedicated to racial equity including, but not limited to corporations, nonprofits, foundations, grantmakers, and coalitions. All entities specific information, including historical financial and public records, will be maintained for public accessibility.

Original Op-Ed's, Podcast, and Report Submission: Clarintel allows freelance reporters, news reporters, journalists, activists, change agents, researchers and entities to submit original opinion editorials, podcasts, and reports for promotion and publication on Clarintel Inc. All reports, podcasts, and editorials submitted must focus on racial equity and spotlight current or historically relevant social issues aligning with Clarintel's mission, values, and impact areas. Submitted content will be reviewed by a member of the Clarintel staff before publication. All published content will credit the original author and all contributing entities.

### Data as a Service

Insights & Analytics: Clarintel offers free insights regarding network activity, audiences, data sharing and shared data usage. Clarintel also provides metrics generated through actionable and information-based content shared to the Phaction App for network partners regardless of Phaction account ownership. This is discussed more in detail below. The insights provided allow network partners to understand, enhance, and master their philanthropic influence, presence, activity, perceptions, audiences, and social impact. The insights provided are discussed in the Network Control Center section of this document and the Insights and Analytics section of the Phaction App. Additional insights will be determined upon further research and development.

Partner Data Sharing: Clarintel provides all network partners with the ability to securely share data and information between each other directly via private channels and through networks shared by multiple network partners. Each network is categorized by a variety of factors, governed by independent regulations, and only accessible to specific network partners aligning with respective network criteria. Partners also have the opportunity to share data and information outside of Clarintel Inc. and Phaction Inc. to public third-party entities including, but not limited to social media platforms, news media and marketing entities, blogs, newsletters and other means of public information distribution.

### Infrastructure & Software as a Service

Cloud Based Applications and Services: Clarintel provides a variety of cloud-based applications and services for free to network partners. The amount of cloud services accessible to each network partner varies based on network activity or services purchased based on entity type, need and usage. The initial cloud services that Clarintel will offer upon release include, but are not limited to: cloud storage, data organization, and data visualizations.

Streamlined Action and Understanding via the Phaction App: Clarintel provides partners with the ability to increase, enhance, and optimize their reach and impressions, public perceptions, engagement rates and conversion rates through the Phaction App. All network partners can host active philanthropic offerings on both Clarintel and Phaction and receive updates in real time regarding goal fulfillments and audience activity. In addition, all insights including activity, engagement, and audience demographics are provided to network partners for free to further enhance social issue approaches and solution effectiveness. Clarintel and Phaction work hand in hand to provide promotional, advertisement, and analytical capabilities specific to each network partner based on need, budget, objectives, goals, theories of change, and social impact.

Clarintel Inc. Solution Structure

Clarintel Inc. is built for the unified advancement of racial equity entities and the centralization and democratization of racial equity focussed data and information. Clarintel's structure is separated into five key components: The Network of Networks, Data STAR (Sharing, Tracking, Analysis, and Reach), Cloud Based Services, Data Collection & Analysis, and Clarintel Executed Initiatives aligning with Clarintel's mission, objectives, and goals. Each element above provides racial equity entities with access to a variety of data, insights, information, tools and resources that will ultimately revolutionize current approaches, strategies, and solutions focussed on issuing in a world grounded by racial equity.

### The Network of Networks

The Clarintel Network of Networks allows the social sector to securely access and exchange data, resources, tools, services, research, strategies, and opportunities with other social sector entities, media entities, and information distribution channels. The Network of Networks aims to optimize and automate social issue responses and solutions, revolutionize social sector collaboration and strategies, and issue in a new age of data focused philanthropy and activism starting with racial equity focussed entities. The Network of Networks model consists of data focused partner guidelines, the strategic partnership model, and the data sharing network model.

### Network Structure

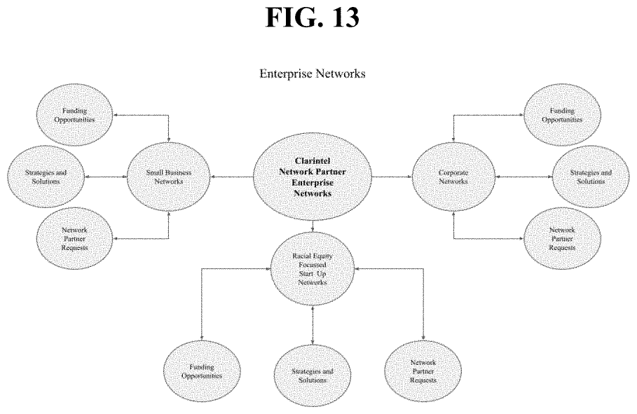

FIGS. 12-15 illustrate example network structures implemented in the example embodiments.

To build the Network of Networks, Clarintel organizes Network Partners into a variety of groups based on organization and entity specific information, partner needs, shared goals, Clarintel Inc. and partner led initiatives, social issues, and other factors found during the execution of research and data analysis strategies. Each network is governed independently with varying levels of access and capabilities.

### Home Bases

Home Bases, or Home Networks, are created in two ways, automatically by using publicized, active pre-existing partnerships held by network partners outside of Clarintel, and manually by adding Network Partners within the Clarintel Network of Networks. Once created, the owning Partner Network has full control and management rights over the access levels of network partners within the home base including but not limited to organization, categorization, and data visibility. Data shared through these networks must align with network goals and objectives. All network partners can create home bases.

Automated: As new entities join the network of networks, Clarintel examines all active partnerships existing outside of Clarintel that are held or managed by the respective entity and updates home bases appropriately. Each automated home base contains the information of the partnership outside of Clarintel including, but not limited to the name, details, goals, partnership purpose, and objectives.

Manual: Network Partners can manually create home bases containing other Network Partners by submitting a network creation request detailing the purpose of the network, societal benefit, project plans and proposals, and other information that will be determined upon further development.

FIG. 12 illustrates an example exploration network.

### Exploration Networks

These types of networks allow network partners to explore social issues and philanthropy related areas of interest and focus based on Phactionroved topics. Entities can be connected to an unlimited amount of exploration networks if approved by Clarintel Inc. staff. Network Partners must prove alignment or justification to the following social issues topics, including, but not limited to: Racial Equity, Climate Change, Healthcare, Mental Health, Police Brutality, Prison Reform, Fair Housing, Education, Voter Suppression, and Policy Reform & Lobbying. All exploration networks are updated in real time by network partners and Clarintel Inc.

FIG. 13 illustrates an example enterprise network.

### Enterprise Networks

These types of networks are built to connect Network Partners to corporations, small businesses, and funders. Clarintel will organize, manage, and mediate connections and information sharing mediums between corporations, funders, and small business and Network Partners within the Network of Networks.

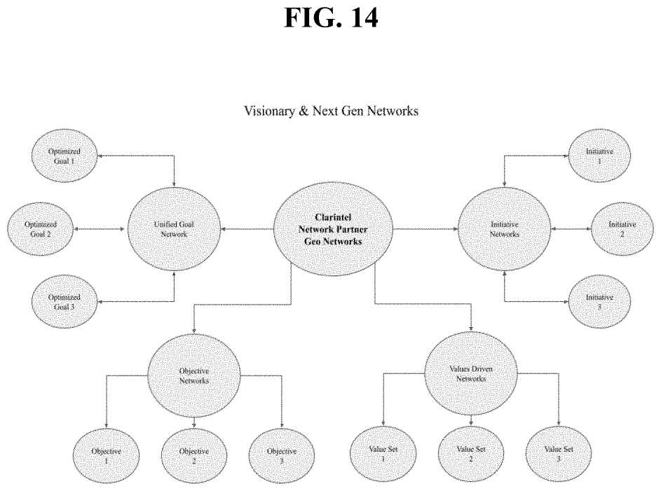

FIG. 14 illustrates an example visionary and next generation network.

### Visionary and Next Gen Networks

These networks are formed based on shared or unified goals, objectives, initiatives, plans, and values focussed on innovative and cutting-edge strategies for driving social impact. This network is specifically for connecting social sector entities to research centers, data centers & databases, educational institutions, and other individuals to the data and information needed to bring groundbreaking visions and ideas to life.

FIG. 15 illustrates an example geo network.

### Geo Networks

These networks are formed based on network partners operating or focusing on specific social issues occurring within various geographical locations. This includes networks formed based on social events and social issue occurrences. For these networks, Network Partners must prove operations within the community, city, region, or geographical area associated with the community network.

A. Regional Biases: These networks are a subset of geo-networks formed to identify and share information and data about biases faced in specific geo locations and regions.

### Data STAR: Sharing, Tracking, Analytics, and Reach

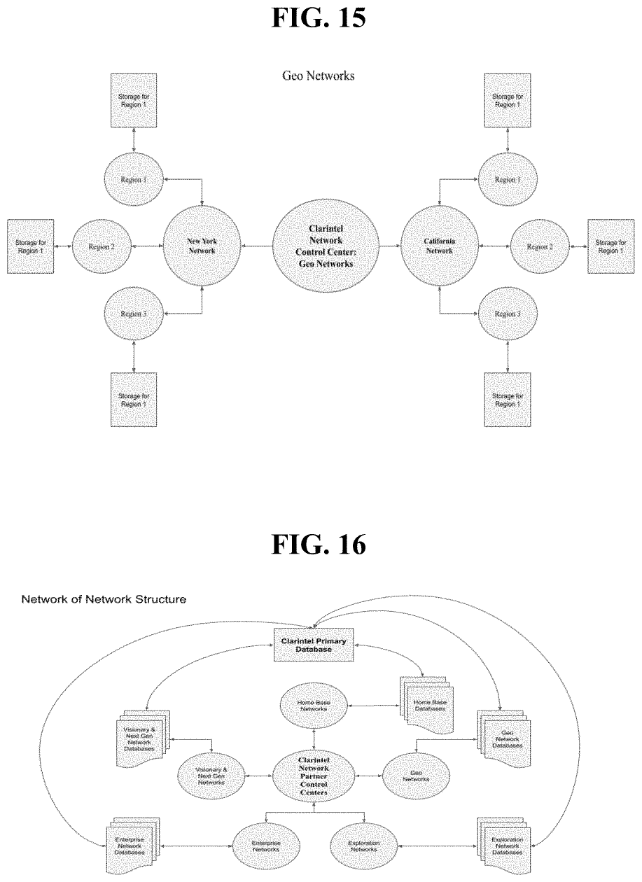

The Network of Networks primarily functions to optimize and manage the secure sharing, exchanging, and transference of data between organizations of similar qualities, goals, and approaches. Each network described above operates independently and jointly to expand Network Partner reach and increase resource accessibility while maintaining organization and security. Network Partners can find measures for analyzing, amplifying, and optimizing strategies executed through the Network of Networks via the Clarintel Network Control Center. The section below details how information and data is shared, managed, and tracked using the Clarintel Network of Networks. (FIG. 16)

### Data Sharing Mechanisms

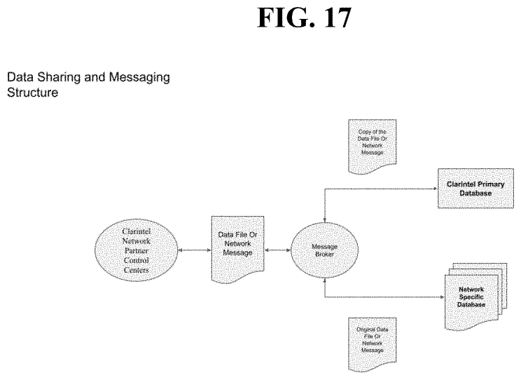

When network partners share data and information to a specific network or group of networks, the original file is stored in the network that the file is shared to. Network partners can save a copy of the original file in their Clarintel Network Control Center for future use. Clarintel also saves a copy of each file shared through all networks for security and auditing purposes. (FIG. 17)

Each network partner is able to share data and information between each other in the following ways:

A. Broadcasting: Entities can share data to all Network partners within a specific network.

B. Multi-Network Sharing: Network Partners can share data and information to other networks that they are a member of.

C. Collaborative Sharing: A network partner can share specific data files and other information to specific partners within a shared network for collaboration efforts. This is useful for simultaneously working on research reports, strategies, and data sets.

D. Direct Shares: A network partner can securely and privately share data and information to another network partner that shares the same network.

E. Exports: Network partners can share data to third party entities including, but not limited to social media platforms, email addresses, text messages, and blogs. Data and information shared from Clarintel Networks to third party entities will include the information of the original network partner that shared the item to Clarintel, Clarintels information, and the sharing accounts information.

F. Phaction Data Sharing: Network partners can share data to their Phaction Account through Clarintel Inc. Depending on the type of data or information shared, network partners receive various sharing capabilities including but not limited to:

F.1 Actions: Network partners can share actionable philanthropic opportunities to Phaction and receive analytics regarding the progress of each offering. Philanthropic offerings shared through Phaction Accounts will be included in their respective account page. Offerings not directly attached to Phaction Accounts will be included in the Phaction Instant Action Page. All network partners can track the progress of their offerings and receive insights on conversions, impressions, and reach from within their Clarintel Network Control Center.

F.2 Information: Network partners can share information and data outside of actionable resources to Phaction. Similar to above, network partners can view insights and analytics generated on Phaction regarding their content frequency, amplification, impressions, engagement, and reach in the Clarintel Network Control Center.

### Clarintel Network Control Center

Network partners can access the Network Partner Control Center to organize, track, and manage all network activity including, but not limited to data and information stored and shared in Clarintel Cloud Storage, networks of membership, active philanthropic opportunities, active networks & network requests, notifications and alerts, and usage insights and analytics.

A. Analytics Dashboard: The landing page of the network control center is the analytics dashboard. The analytics dashboard contains numerous visualizations displaying a variety of usage metrics including, but not limited to impressions, engagement, and reach regarding DACs hosted on Phaction and Clarintel, data items shared to networks, and network partner activity.

B. Account Management: Network partners can manage account information including, but not limited to their headquarters, chapters, individual and admin access and permissions, specific partners, contact information, theory of change, objectives, and goals.

C. Network Management: All network accessibility, including specific network partner accessibility, and data sharing preferences can be managed through the Network Control Center. Network partners can both request to join other networks via a keyword search, and send invites to other accounts for admission into specific networks. Requests from other network partners are also visible in the Network Control Center. Once accepting a network request, the network partner is automatically added to the respective network. All joined networks can be found and managed by network partners via a list within the network control center.

D. Cloud Storage Management: Through the network control center, network partners can view all data uploaded to Clarintel. For each data item, network partners will be able to view specific metadata including the time the file was shared and uploaded, network placement, share history, and the specific network partners that accessed a file stored in your Cloud Storage that was also shared publicly through a network.

E. Digital Acts of Care Management: In addition to the data and information shared via the Network of Networks, network partners can manage all digital acts of care supported, sponsored, partnered, created or hosted on Clarintel and Phaction.

F. Optimized Data Visualizations: The network control center provides the ability for network partners to create visualizations from data stored in their Cloud Storage. When network partners create data visualizations, the visualization is stored as a file in the network partners cloud storage. The network partner can share the visualization file to network partners and networks. In addition, the visualization file can be exported and downloaded for external use.

G. Notifications and Alerts: Network partners receive notifications for all activity, including but not limited to data shares, network request, network admissions, network specific updates such as data uploads, and data item views and engagements. Notifications can be disabled from within account management.

### Nonprofit Marketplace for Data and Goods

Clarintel will provide network partners with the ability to sell philanthropy and social issue related data, insights, solutions, strategies, and goods through Clarintel. Depending on the data and goods sold through Clarintel by network partners, purchasable items may either be limited to only network partners or available for public consumption. Purchasing items in the marketplace will either function via donations or sales purchases depending on the entity and goods sold. The marketplace, including items posted in the marketplace, are governed by the Clarintel Network of Networks Terms and Agreements, however, there are no restrictions on the amount of goods an entity can sell.

### Cloud Based Services

Clarintel provides Network Partners with access to a variety of cloud based services for organizing and digitizing their operations, solutions, strategies, and information. Unlike other cloud-based service providers, Clarintel's cloud space provides tracking tools and measures specific to philanthropy and social action and provides network partners with full control over the security, privacy, and management of data storage, scaling, and sharing. Clarintel offers three primary forms of cloud-based services:

### Cloud Storage

All network partners are provided with cloud storage, free of charge, through admission into the Network of Networks. Network partners can access their cloud storage through their Network Control Center and have full control over the data shared and stored within their cloud storage. A copy of all information and data shared through Networks and saved by the network partner is stored within Clarintel's Cloud Storage specific to the sharing network partner. Additional cloud storage is provisioned in two ways: by sharing content in networks or by paying for additional space on an “as-needed” basis, meaning that all network partners only pay for the space they use. This means that an entity can either pay for additional storage to privately manage their data, or receive additional cloud storage for free by increasing the amount of data and information shared to other network partners. The types of information that can be stored includes, but is not limited to documents, files, pdf, videos, images, links, records, reports, and any other file or document type needed for network partner needs.

### Data Organization

For network partners utilizing Clarintels Cloud Storage, Clarintel will offer automated strategies and approaches for organizing uploaded data and information by file type, keywords, subject, titles, topics, events, budgets, objectives, audiences demographics, and other factors that will be determined upon further development and research.

### Data Visualizations & Analysis

In addition to the above, network partners can access tools for visualizing and analyzing all numerical or language-based information uploaded to their cloud storage. Clarintel utilizes a variety of natural language processing AI models and machine learning algorithms to detect, analyze, and visualize trends in network partner data. Similar to the scaling of cloud storage, additional data and visualization tools will be provided to network partners based on either the frequency and amount of information and data shared through the Network of Networks, or by purchasing or leasing access to a specific data visualization or analytical tool.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed to have a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A philanthropic method, comprising:
receiving data from a plurality of data sources at a first network platform;
transmitting the received data from the first network platform to a second network platform, and
performing, by a user, one or more user-controlled philanthropic activities and social action operations at the second network platform based on the received data.

2. The method of claim 1, wherein the data comprises philanthropic information and social information.

3. The method of claim 1, wherein the second network platform is configured to provide educational resources, social issues resources, and philanthropic resources to one or more users.

4. The method of claim 1, wherein the second network platform is configured to provide an account-based interface for a plurality of users to interact based on philanthropic interests and social interests.

5. The method of claim 1, wherein the first network platform is configured to receive information, and validate and organize the received information based on a determined relevance that is based on social issues and philanthropic information.

6. A philanthropic system, comprising:
receiving, at a first network platform, data collected from a plurality of data sources; and
transmitting the received data from the first network platform to a second network platform;
wherein the second network platform comprises a user interface configured to receive one or more inputs from a user to perform one or more user-controlled philanthropic activities, social action, and social operations at the second network platform based on the received data.

7. A system, comprising:
a decentralized peer-to-peer data network;
a first platform, connected to the peer-to-peer data network;
one or more second platforms, connected to the peer-to-peer network; and
an interface, configured to share one or more of philanthropic information, societal information, research information, and insights between the first platform and the one or more second platforms.
